(19) United States
(12) Patent Application Publication
(10) Pub. No.: US 2013/0024125 A1
(43) Pub. Date: Jan. 24, 2013

(54) STATISTICAL ANALYSIS OF MEDICAL THERAPY OUTCOMES

(71) Applicants: Theodore Lystig, Shoreview, MN (US); Richard Kuntz, Minneapolis, MN (US)

(72) Inventors: Theodore Lystig, Shoreview, MN (US); Richard Kuntz, Minneapolis, MN (US)

(73) Assignee: MEDTRONIC, INC., Minneapolis, MN (US)

(21) Appl. No.: 13/210,242

(22) Filed: Aug. 15, 2011

Related U.S. Application Data
(60) Provisional application No. 61/510,946, filed on Jul. 22, 2011.

(51) Int. Cl. G06F 19/10; G06F 17/18

(52) U.S. Cl. 702/19

(57) ABSTRACT

A method for evaluating a medical therapy with a computing device comprises accessing a data storage system to obtain baseline characteristics for a population of patients who each receive a medical therapy, accessing baseline characteristics and one or more post-therapy outcomes for a subset of the population, and accessing an association between the baseline characteristics and the post-therapy outcomes in the subset. The method further includes modeling the distribution of the post-therapy outcomes in the population based on the distribution of the post-therapy outcomes in the subset and further based on a comparison of the distribution of the of the baseline characteristics in the subset with the distribution of the baseline characteristics in the population, and storing an indication of the modeled distribution of the post-therapy outcomes in the population of patients on the data storage system.

This application claims the benefit of U.S. Provisional Application No. 61/510,946, entitled, “STATISTICAL ANALYSIS OF MEDICAL THERAPY OUTCOMES,” and filed on Jul. 22, 2011, the entire content of which is incorporated herein by reference.

### TECHNICAL FIELD

This disclosure relates to analysis of information relating to medical therapies.

### BACKGROUND

Before an organization can market a medical therapy, governmental organizations or other regulatory bodies ordinarily need to approve the medical therapy. For example, the United States Food and Drug Administration (FDA) approves medical devices and pharmaceuticals before the organization can market them in the United States. In order to receive such approval, the organization may need to conduct a pre-approval study, such as a clinical study, to test the safety and efficacy of the medical device or pharmaceutical.

After an organization receives approval to market a medical therapy, the organization can market the medical therapy in various ways. For example, the organization can market the medical therapy by selling the medical therapy, distributing the medical therapy, educating people on how to use the medical therapy, providing the medical therapy for free, or performing other actions that tend to increase the use of the medical therapy. After the organization receives approval to market the medical therapy, it may be desirable for the organization to know outcomes on patients receiving the medical therapy. To determine the outcomes on patients, the organization may conduct a post-approval study. In some instances, the organization may be required to conduct the post-approval study as a condition for receiving marketing approval. In other words, the organization may be required to conduct a condition of approval study of the therapy. During the post-approval study, investigators may follow a group of patients who have received the medical therapy. The investigators may collect information from the patients over a period of time, and analyze the information to determine the outcomes on the patients.

A standard technique for determining the effect of a therapy within an entire parent population involves conducting a study of the therapy within a portion of the population, e.g., the patients in a post-approval study, estimating the effect of the therapy within the study, and then claiming that the estimated effect can be extrapolated without modification to the entire population that receives the therapy including both those in the post-approval study and those not participating in the post-approval study.

### SUMMARY

In one aspect, this disclosure describes techniques for facilitating analysis of information relating to medical therapies delivered to patients. Data is received from multiple data sources. For example, data can be received from one or more pre- or post-approval studies and one or more other sources of data. The data received from the data sources may provide information about patients in a population who have received one or more therapies. Patient-centric records may be generated at one or more computing devices. Each of the patient-centric records comprises patient data regarding a different patient in the population. The patient data in the patient-centric records is based on the data received from the data sources.

In another aspect, this disclosure relate to techniques for analyzing a set of patient data with a computing device to estimate a post-therapy outcome. Disclosed are techniques for modeling the distribution of post-therapy outcomes in a patient population based on the distribution of the post-therapy outcomes in a subset of the patient population. The techniques include using the computing device to compare the distribution of baseline characteristics of a population subset with the distribution of baseline characteristics in the entire population. Based on this comparison, the distribution of therapy outcomes in the population subset may be modified according to the distribution of baseline characteristics of the entire population in order to model the distribution of outcomes for the entire population. Such techniques may be used to account for important differences in the distribution of baseline characteristics of a population subset as compared to the entire population of patients.

In one example, a method facilitates analysis of outcomes of medical therapies. The method comprises receiving data from multiple data sources. The data from the data sources provides information about patients in a population. Each of the patients in the population has received one or more of the therapies. The method also comprises generating patient-centric records in a computing device. Each of the patient-centric records comprises patient data regarding a different patient in the population. The patient data of the patient-centric records is based on the data received from the data sources.

In another example, a computing device comprises a data storage system that stores instructions. The computing device also comprises a processing system coupled to the data storage system. The processing system reads the instructions from the data storage system and executes the instructions. Execution of the instructions by the processing system causes the computing device to generate patient-centric records. Each of the patient-centric records comprises patient data regarding a different patient in a population. The patient data of the patient-centric records is based on data received from multiple data sources. The data from the data sources provides information about the patients in the population. Each of the patients in the population has received one or more therapies.

In yet another example, a computer storage medium stores instructions. Execution of the instructions by a processing system of a computing device causes the computing device to generate patient-centric records. Each of the patient-centric records comprises patient data regarding a different patient in a population. The patient data of the patient-centric records is based on data received from multiple data sources. Each of the patients in the population has received one or more therapies.

In yet another example, a computing device comprises means for receiving data from multiple data sources. The data from the data sources provides information about patients in a population. Each of the patients in the population has received one or more of the therapies. The computing device also comprises means for generating patient-centric records. Each of the patient-centric records comprises patient data regarding a different patient in the population. The patient data of the patient-centric records is based on the data received from the data sources.

In one example, this disclosure is directed to a method for evaluating a medical therapy with a computing device. The method comprises accessing, with the computing device, a data storage system to obtain baseline characteristics for a population of patients who each receive a medical therapy, accessing, with the computing device, the data storage system to obtain baseline characteristics and information regarding one or more post-therapy outcomes for a subset of the population of patients, accessing the data storage system to obtain an indication of an association between at least one aspect of the baseline characteristics and at least one of the post-therapy outcomes in the subset of the population, modeling, with the computing device, a distribution of the at least one post-therapy outcome in the population based on a distribution of the at least one post-therapy outcome in the subset of the population and further based on a comparison of a distribution of the at least one aspect of the baseline characteristics in the subset of the population with a distribution of the at least one aspect of the baseline characteristics in the population, and storing, with the computing device, an indication of the modeled distribution of the at least one post-therapy outcome in the population of patients on the data storage system.

In another example, a computing device comprises a data storage system and a processing system coupled to the data storage system. The data storage system stores baseline characteristics for a population of patients who each receive a medical therapy, and baseline characteristics and information regarding one or more post-therapy outcomes for a subset of the population of patients. The processing system reads instructions from the data storage system and executes the instructions, execution of the instructions by the processing system causing a computing device to model a distribution of at least one post-therapy outcome in the population based on a distribution of the at least one post-therapy outcome in the subset of the population and further based on a comparison of a distribution of at least one aspect of the baseline characteristics in the subset of the population with the distribution of the at least one aspect of the baseline characteristics in the population, and store an indication of the modeled distribution of the at least one post-therapy outcome in the population of patients on the data storage system.

In another example, this disclosure is directed to a computer storage medium that stores instructions. Execution of the instructions by a processing system of a computing device causes the computing device to access baseline characteristics for a population of patients who each receive a medical therapy, access baseline characteristics and information regarding one or more post-therapy outcomes for a subset of the population of patients, access an indication of an association between at least one aspect of the baseline characteristics and at least one of the post-therapy outcomes in the subset of the population. Execution of the instructions further causes the computing device to model a distribution of the at least one post-therapy outcome in the population based on a distribution of the at least one post-therapy outcome in the subset of the population and further based on a comparison of a distribution of the at least one aspect of the baseline characteristics in the subset of the population with the distribution of the at least one aspect of the baseline characteristics in the population, and store an indication of the modeled distribution of the at least one post-therapy outcome in the population of patients on a data storage system.

In a further example, this disclosure is directed to a system comprising means for modeling the distribution of post-therapy outcomes in a population of patients based on a distribution of the post-therapy outcomes in a subset of the population and further based on a comparison of a distribution of baseline characteristics in the subset of the population with a distribution of the baseline characteristics in the population, and means for storing an indication of the modeled distribution of the post-therapy outcomes in the population of patients on a data storage system.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a block diagram that illustrates an example system in which patient-centric records are used to facilitate analysis of medical therapies.

FIG. 2 is a block diagram that illustrates an example set of data sources.

FIG. 3 is a block diagram that illustrates example components of an integration system.

FIG. 4 is a block diagram that illustrates example components of a patient-centric record.

FIG. 5 is a block diagram that illustrates example details of an analysis system.

FIG. 6 is a flowchart of an example operation in which patient-centric records are used to analyze outcomes of medical therapies.

FIG. 7 is a block diagram that illustrates an example data source.

FIG. 8 is a flowchart of an example operation of a data source in which an electronic data collection (EDC) interface is adapted based on data of patient-centric records.

FIG. 9 is a block diagram that illustrates an example computing device.

FIG. 10 is a flowchart illustrating techniques for modeling the distribution of post-therapy outcomes in a population based on the distribution of the post-therapy outcomes in a subset of the population.

### DETAILED DESCRIPTION

This disclosure describes techniques for facilitating analysis of information relating to one or more medical therapies. Such techniques can include receiving data from multiple data sources. The data may provide information about patients who have received one or more medical therapies. Furthermore, such techniques may include using the data to generate patient-centric records. The patient-centric records may be used to perform analysis operations that generate information about outcomes of the medical therapies. For example, the analysis operations may be applied to draw inferences with respect to post-approval outcomes of the medical therapies. In another example, the analysis operations may be applied to draw inferences regarding patients based on more detailed data regarding other patients. As will be described, the techniques described may be performed, in whole or in part, by one or more computing devices configured to support the techniques.

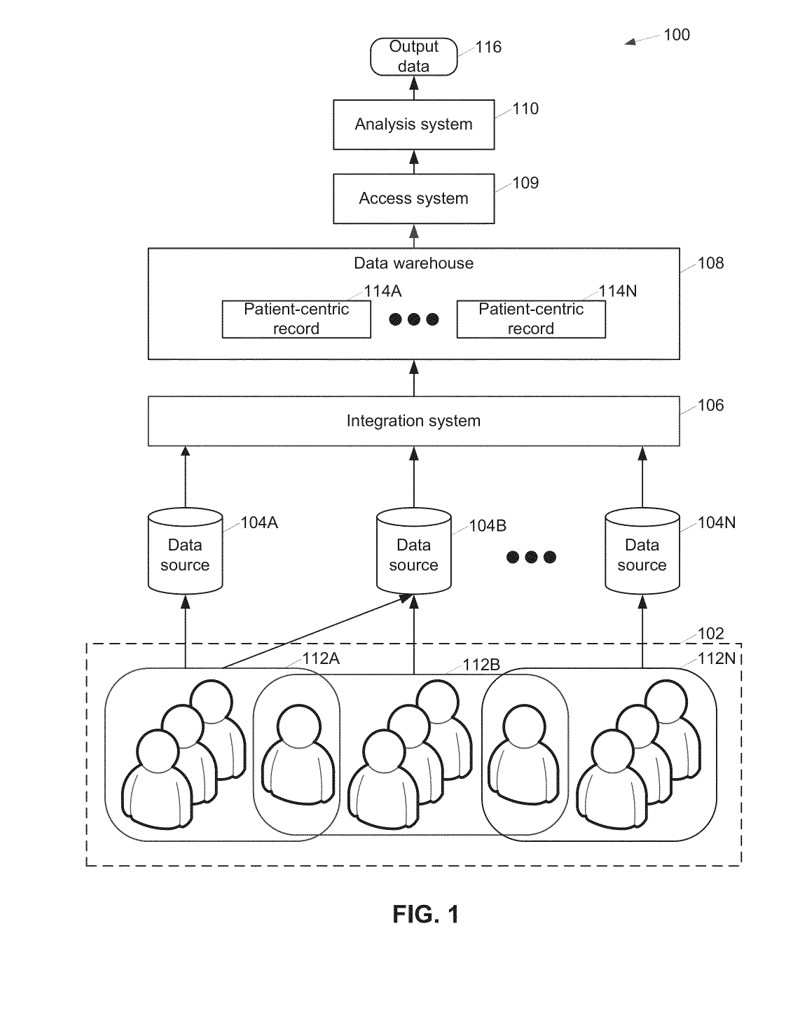

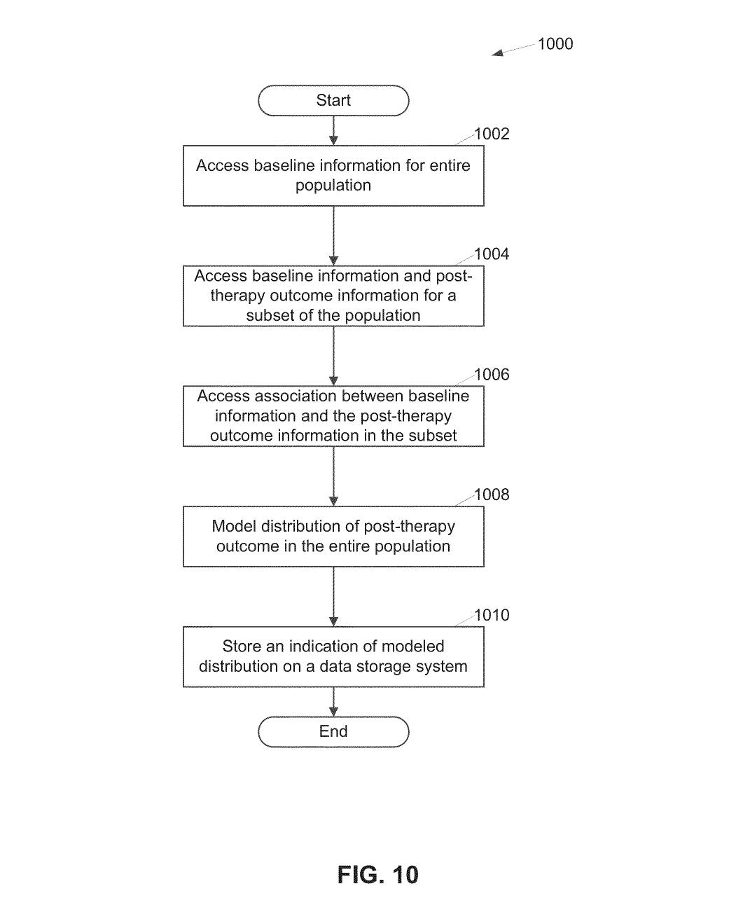

Modeling the distribution of post-therapy outcomes in a patient population based on the distribution of the post-therapy outcomes in a subset of the patient population uses data representing the distribution of baseline characteristics of a population subset relative to the distribution of baseline characteristics in the entire population. Based on a comparison of the relative distribution of baseline characteristics of a population subset, the distribution of therapy outcomes in the population subset may be modified according to the distribution of baseline characteristics of the entire patient population. Such techniques may be used to account for important differences in the distribution of baseline characteristics in a population subset as compared to the entire population of patients. Techniques including exemplary computing devices, systems and networks suitable for performing the statistical techniques disclosed herein are described with respect to FIGS. 1-9. In addition, techniques for modeling the distribution of post-therapy outcomes in a patient population are described in detail with respect to FIG. 10.

The attached drawings illustrate examples. Elements indicated by reference numbers in the attached drawings correspond to elements indicated by like reference numbers in the following description. In the attached drawings, ellipses indicate the presence of one or more elements similar to those separated by the ellipses. Furthermore, stacked elements in the attached drawings indicate the presence of one or more similar elements. Alphabetical suffixes on reference numbers for similar elements are not intended to indicate the presence of particular numbers of the elements. In this document, elements having names that start with ordinal words (e.g., “first,” “second,” “third,” and so) do not necessarily imply that the elements have a particular order. Rather, such ordinal words are merely used to refer to similar elements.

FIG. 1 is a block diagram that illustrates an example system 100 in which patient-centric records are used to facilitate analysis of information relating to one or more medical therapies. In the example of FIG. 1, system 100 comprises data sources 104A through 104N, an integration system 106, a data warehouse 108, an access system 109, and an analysis system 110. This disclosure can refer to data sources 104A through 104N collectively as “data sources 104.” Readers will understand that other examples may include more, fewer, or different components than those shown in FIG. 1.

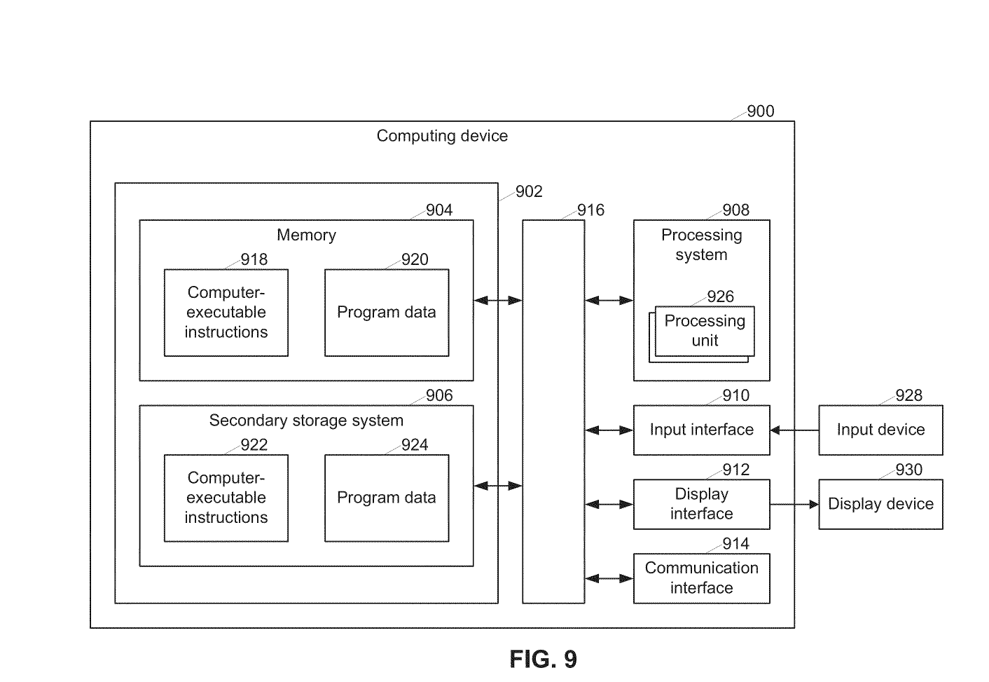

Data sources 104, integration system 106, data warehouse 108, access system 109, and analysis system 110 can each be provided by one or more computing devices. A computing device is a physical device or device component that processes data. Example types of computing devices include personal computers, laptop computers, smartphones, tablet computers, mainframe computers, supercomputers, network attached storage devices, storage area network devices, intermediate network devices, processing units, integrated circuitry, computer subsystems, and other types of physical devices or components of devices that process data. FIG. 9, described in detail below, illustrates example components of a computing device. In some examples, data sources 104, integration system 106, data warehouse 108, access system 109, and analysis system 110 are provided by one or more computing devices of the type illustrated in the example of FIG. 9. In instances where multiple computing devices provide data sources 104, integration system 106, data warehouse 108, access system 109, and/or analysis system 110, the computing devices may be communicatively coupled, but not necessarily co-located.

A population 102 includes a plurality of patients. Each of the patients in population 102 has received one or more medical therapies. In accordance with this disclosure, patients in population 102 may receive any of a wide range of therapies. For example, population 102 can include patients who have received one or more pharmaceuticals, patients who have received one or more implantable medical devices, patients who have or use one or more non-implantable medical devices, and/or patients who have received other medical therapies. Example types of pharmaceuticals can include chemical and biological compounds. Some other examples of medical therapies include, but are not limited to, implantable pacemakers, deep brain stimulators, pelvic floor stimulators, gastrointestinal stimulators, peripheral nerve stimulators, functional electrical stimulators, insulin pumps, optical stimulators, artificial cardiac valves, spinal implants, orthopedic implants, drugs, pharmacological agents, biological agents, gene therapy agents, pain relief agents, and a wide range of other therapies. The therapies can include combination therapies in which multiple medical device components are used and combination therapies in which one or more medical devices are used in conjunction with one or more pharmaceuticals, or in which multiple pharmaceuticals are used. In some instances, patients in population 102 receive therapies that are actually placebos, such as sugar pills. Furthermore, in some instances, one or more patients in patient 102 who have a condition potentially treatable with a given therapy do not receive the given therapy, but instead receive typical standard-of-care treatment.

In some examples, all of the patients in population 102 have received medical therapies marketed by a single organization. For example, a medical device manufacturer can market an implantable defibrillator device, an implantable drug pump, and an implantable coronary artery stent. In this example, each patient in population 102 has received at least one of the defibrillator device, the drug pump, and the coronary artery stent. In other instances, patients in population 102 have received medical therapies marketed by multiple organizations. That is, in such instances, at least two of the therapies received by the patients in population 102 are marketed by different organizations. Furthermore, patients in population 102 may receive therapies that have components marketed by multiple organizations. For example, a patient may receive a cardiac rhythm management therapy that comprises one or more leads marketed by a first organization and a generator marketed by a second organization.

The medical therapies can include pre-approval therapies and/or post-approval therapies. A pre-approval therapy is a medical therapy that has not yet received marketing approval from the appropriate governmental or other regulatory organizations. A pre-approval therapy may be delivered, for example, as part of a clinical trial or under a humanitarian exemption from regulatory approval. A post-approval therapy is a medical therapy that has received marketing approval from the appropriate governmental or other regulatory organizations.

Population 102 includes a plurality of sub-populations 112A through 112N (collectively, “sub-populations 112”). Patients in each of sub-populations 112 include patients who have received a given medical therapy. For example, the patients in sub-population 112A can include patients who have received a particular implanted cardiac defibrillator device. In this example, the patients in sub-population 112B can include patients who have received a particular implanted deep brain stimulator (DBS) device.

Sub-populations 112 can overlap. In other words, a given patient can be in two or more of sub-populations 112. For example, sub-population 112A can include patients who have received a particular implanted cardiac defibrillator device and sub-population 112B can include patients who have received a particular implanted DBS device. In this example, a given patient who has received the particular implanted cardiac defibrillator device and the particular implanted DBS device is in sub-population 112A and concurrently is in sub-population 112B.

One or more computing devices provide each of data sources 104. As described in detail elsewhere in this disclosure, a computing device can provide one of data sources 104 in various ways. For example, a computing device can provide one of data sources 104 by providing access to one or more databases. Databases include data structures for storage and retrieval of data. Example types of databases include relational databases, online analytical processing (OLAP) cubes, file systems, files, information management systems, and other types of data structures for storage and retrieval of data. In another example, a computing device can provide one of data sources 104 by providing access to a data warehouse. In this example, the data warehouse can load data from one or more other data sources. A data warehouse can be a database that is used for reporting data. In yet another example, a computing device can provide one of data sources 104 by providing access to a set of files.

Data sources 104 provide data regarding patients in population 102 to integration system 106. Data sources 104 can provide various types of data to integration system 106. For example, data sources 104 can provide health information of the patients in population 102. In this example, the health information can include any of a wide variety of information, such as body weight, blood pressure levels, pulse rate, clotting issues, incidents of stroke, incidents of cancer, incidents of myocardial infarction, incidents of angina, incidents of bacterial or viral infection, psychological disturbances or lucidity, mortality, and other information about the physical or mental health of the patients in population 102. In another example, data sources 104 can provide health information and non-health information regarding the patients in population 102. Example types of non-health information can include income information, place of employment, place of residence, contact information, customer-relationship management data, demographic information, information regarding healthcare provider of patients, and other information not strictly related to the health of the patients in population 102.

Furthermore, data sources 104 can provide data related to pre- and post-approval studies of medical therapies. A pre-approval study of a medical therapy is a study conducted before an organization receives approval to market the medical therapy. A post-approval study of a medical therapy is a study conducted after an organization receives approval to market the medical therapy. During pre- and post-approval studies, investigators follow a group of patients who have received a medical therapy. The group may be relatively small in relation to the size of the general population of patients. The investigators may collect detailed information from these patients over a period of time. The investigators analyze the collected information to determine the outcomes of the therapy on the patients in the pre- or post-approval study. The investigators then extrapolate the results of this analysis to the general population of patients.

In addition, data sources 104 can include data sources associated with different healthcare sites. Example types of healthcare sites include hospital networks, hospitals, doctor's offices, clinics, and other sites where medical therapies are provided to patients. A data source associated with a given healthcare site can provide data regarding patients treated at the given healthcare site. For example, data sources 104 can include a data source associated with a first hospital and can include a data source associated with a second hospital. In this example, the data source associated with the first hospital can provide treatment records for patients treated at the first hospital and the data source associated with the second hospital can provide treatment records for patients treated at the second hospital.

In some instances, two or more of data sources 104 provide data regarding patients in a single one of sub-populations 112. For example, data source 104A can provide data regarding patients in sub-population 112A, data source 104B can provide data regarding patients in sub-population 112B, and so on. In the example of FIG. 1, data source 104B provides data regarding patients in sub-population 112A and information regarding patients in sub-population 112B.

In some instances, a given one of data sources 104 provides data regarding some, but not all, of the patients in a given one of sub-populations 112. For example, the given data source can provide data regarding patients who participated in a post-approval study of a given therapy. In this example, the sub-population corresponding to the given therapy can include patients in addition to those participating in the post-approval study.

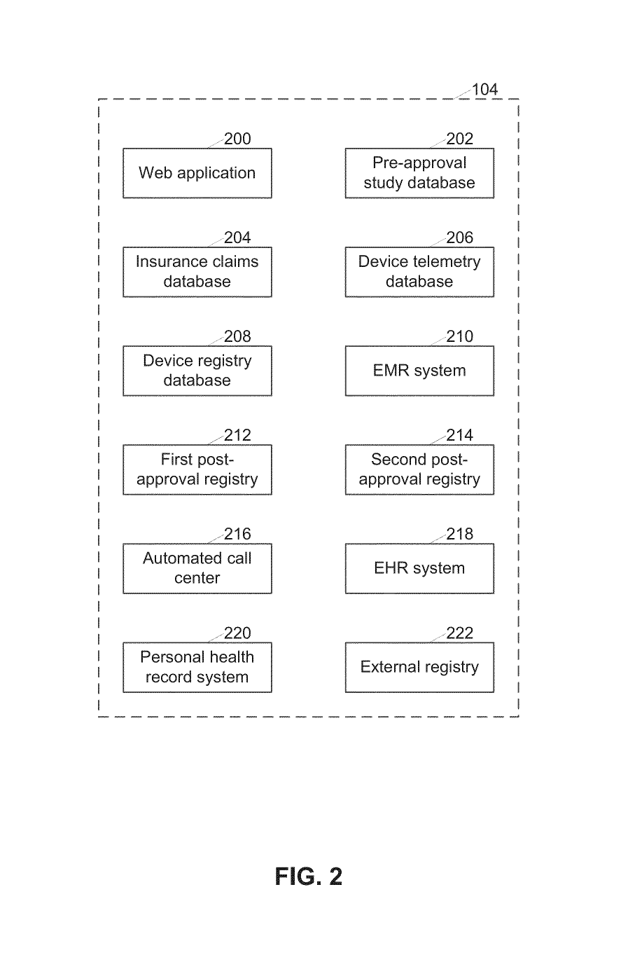

In various examples, the set of data sources 104 in system 100 includes various types of data sources. FIG. 2, described in detail elsewhere in this disclosure, illustrates data sources in one example set of data sources. Readers will understand that other examples include data sources different than those illustrated in the example of FIG. 2.

Integration system 106 processes data provided by data sources 104 to generate or modify patient-centric records 114A through 114N (collectively, “patient-centric records 114”) in data warehouse 108. Patient-centric records 114 provide patient data regarding different ones of the patients in population 102. For example, patient-centric record 114A can provide patient data regarding one of the patients in population 102, patient-centric record 114B can provide patient data regarding another one of the patients in population 102, and so on. In this disclosure, a patient-centric record can be said to correspond to or be “for” a given patient when the patient-centric record provides patient data regarding the given patient. In some examples, integration system 106 generates patient-centric records 114 such that each of patient-centric records 114 conforms to the same schema. The schema defines an allowable structure for patient-centric records 114.

Data warehouse 108 stores patient-centric records 114. Data warehouse 108 can be implemented in various ways. For example, data warehouse 108 can be implemented as one or more databases stored on one or more computing devices. In this example, the one or more databases can include relational databases, OLAP cubes, one or more XML documents, or other types of data structures for storage and retrieval of data. In another example, data warehouse 108 can be implemented by one or more computing devices that store patient-centric records 114 virtually. In this example, the one or more computing devices of data warehouse 108 behave as though patient-centric records 114 are stored in data warehouse 108. However, in this example, the one or more computing devices of data warehouse 108 actually generate patient-centric records 114 dynamically in response to requests for extraction of data from data warehouse 108.

Integration system 106 generates or modifies patient-centric records 114 based on data from the data sources 104. For example, if data warehouse 108 does not store a patient-centric record that corresponds to a given patient in population 102, integration system 106 can generate a patient-centric record in data warehouse 108 when integration system 106 receives data regarding the given patient from one or more of data sources 104. In this example, if data warehouse 108 stores a patient-centric record corresponding to the given patient, integration system 106 can modify the patient-centric record when integration system 106 receives data from data sources 104 regarding the given patient.

Integration system 106 can generate patient-centric records 114 in various ways. For example, integration system 106 can copy the data from data sources 104 into patient-centric records 114. In another example, integration system 106 can generate new data based on data from data sources 104. In this example, integration system 106 can store the new data in the patient-centric records. In yet another example, integration system 106 can generate data in patient-centric records 114 that indicate how to retrieve particular pieces of data from data sources 104. For instance, patient-centric records 114 can indicate queries or resource identifiers that can be used to retrieve data from data sources 104.

The data of a patient-centric record can be based on the data from multiple ones of data sources 104. For example, integration system 106 can receive data from data source 104A and data from data source 104B. In this example, the data from data source 104A conveys information about patients who have participated in a post-approval study of a first therapy and the data from data source 104B conveys information about patients who have received a second therapy. Furthermore, in this example, integration system 106 generates patient-centric records 114 corresponding to that subset of the patients in population 102 who received both the first therapy and the second therapy. In this example, patient-centric records 114 for the patients in this subset store patient data based on both data from data source 104A and data from data source 104B.

Access system 109 extracts data from patient-centric records 114 in data warehouse 108. Patient-centric records 114 can each conform to a schema. The schema defines an allowable internal structure of patient-centric records 114. Because each of patient-centric records 114 conforms to the schema, access system 109 can extract data from each of patient-centric records 114 in the same way. For example, access system 109 can use a single search query to identify each of patient-centric records 114 that contain a particular value.

Analysis system 110 uses the extracted data to perform an analysis operation on patient-centric records 114. Analysis system 110 generates output data 116 based on results of the analysis operation. In various embodiments, analysis system 110 performs various analysis operations and generates various types of output data 116. For example, analysis system 110 can extract from patient-centric records 114 data regarding therapies in a given category of therapies. In this example, analysis system 110 can then perform an analysis operation that generates information about outcomes of the category of therapies. For instance, analysis system 110 can perform an analysis operation that draws inferences about outcomes of the categories of therapies, such as the safety and/or efficacy of a certain category of medical devices. In another example, analysis system 110 can use the patient-centric records to generate output data 116 that indicate trends of utilization and/or pricing of therapies.

Output data 116 can be formatted in various ways. For example, output data 116 can be formatted as one or more elements of a graphical user interface (GUI). In another example, output data 116 can be formatted as one or more extensible markup language (XML) documents. In yet another example, output data 116 can be formatted as one or more Hypertext Markup Language (HTML) documents, spreadsheet documents, graphical images, relational database records, and in other formats. In yet another example, the output data 116 can comprise one or more reports in a business intelligence system.

Although not illustrated in the example of FIG. 1 for the sake of clarity, system 100 can, in some instances, include one or more additional integration systems and one or more additional data warehouses. In such instances, the additional integration systems function in manners similar to that of integration system 106. The additional integration systems can receive data from one or more of data sources 104 and/or additional data sources and generate patient-centric records in the additional data warehouses. The patient-centric records in the additional data warehouses can conform to schemas different than that used in data warehouse 108. Access system 109 can extract data from data warehouse 108 and the additional data warehouses. When access system 109 extracts data from multiple data warehouses, access system 109 can perform an operation that processes the extracted data into a single result set. Access system 109 provides the result set to analysis system 110.

Because the records in data warehouse 108 are patient-centric, as opposed to being segregated into studies regarding individual therapies or by healthcare sites, it may be easier for analysis system 110 to generate data regarding therapies. For example, a given patient in population 102 may receive a medical therapy at a first healthcare site in a first city. The given patient may then move to a second city where a second healthcare site treats the given patient. The first healthcare site and the second healthcare site can store separate records for the given patient. However, data provided by the patient-centric record for the given patient can be based on the records from both the first healthcare site and the second healthcare site. Because it may not be necessary to access records from both healthcare sites, it may be less complex to determine outcomes of the medical therapy on the given patient.

In another example, one of data sources 104 can provide results of a pre- or post-approval study of a medical therapy. Furthermore, data sources 104 can provide information about patients who received the medical therapy but who did not participate in the pre- or post-approval studies. Because patient-centric records 114 for participating patients and non-participating patients can be extracted from data warehouse 108 in the same way, it may be less complicated for analysis system 110 to compare information, e.g., baseline information, regarding participating patients who have received a given therapy with information regarding non-participating patients who have received the given therapy. This may make it easier to extrapolate findings on outcomes from the participating patients to the non-participating patients.

In yet another example, a category of medical therapies can include several related medical therapies. In this example, data sources 104 can provide information regarding patients who received the medical therapies. Because patient-centric records 114 for these patients can be extracted from data warehouse 108 in the same way, it may be less complicated to compare outcomes of these medical therapies. Furthermore, in this example, it may be less complicated to draw inferences about the outcomes of the category of medical therapies.

FIG. 2 is a block diagram that illustrates an example set of data sources 104. As illustrated in the example of FIG. 2, the set of data sources 104 includes a web application 200, a pre-approval study database 202, an insurance claims database 204, a device telemetry database 206, a device registry database 208, an Electronic Medical Records (EMR) system 210, a first post-approval registry 212, a second post-approval registry 214, an automated call center 216, an electronic health record (EHR) system 218, a personal health record system 220, and an external registry 222. In each case, one or more computing devices configured to collect and/or deliver data provide the data sources 104 illustrated in the example of FIG. 2. Readers will understand that data sources 104 shown in FIG. 2 are examples and that other examples can include more, fewer, or different data sources. It should also be noted that the data in each of the various data sources 104 may be organized in varying formats or structures and data fields may not necessarily coincide for any given two data sources 104. To that end, examples of the present disclosure facilitate generation of patient-centric records from data obtained from one or more of data sources 104.

Web application 200 collects data regarding patients in one or more of sub-populations 112 via a communication network, such as the World Wide Web, an intranet, a local area network, or another type of communication network. A server device executes web application 200. In some examples, web application 200 can include a commercially-available data capture tool, such as an OUTCOMELOGIX™ data capture tool provided by Oracle Corp. of Redwood Shores, Calif., a RAVE® data capture tool provided by Medidata Solutions of New York, N.Y., an INFORM™ data capture tool provided by Oracle Corp., or a MYEDC™ data capture tool provided by Merge Healthcare of Chicago, Ill. As part of executing web application 200, the server device provides data representing an electronic data collection (EDC) interface to a client device. The client device renders the data to display the EDC interface to a user of the client device. The user of the client device enters data into one or more data entry features in the EDC interface. Example data entry features include textboxes, text areas, radio buttons, checkboxes, drop-down boxes, and other on-screen features that receive input from users. When the patients select a submit feature of the EDC interface, the client device sends the entered data to web application 200. Web application 200 then provides the entered data to integration system 106. In this way, web application 200 collects the information regarding the patients.

The user of the client device can be various types of people. For example, the user can be a physician. In another example, the user can be one of the patients in population 102. In yet another example, the user can be a call center technician. In this example, the call center technician calls a patient, asks the patient questions from the EDC interface, and enters the patient's answers into the data entry features of the EDC interface.

Web application 200 can collect various types of data. For example, web application 200 can collect information regarding the health of the patients, activities in which the patients engage, opinions of the patients, symptom complaints, medical device behavior, and other types of data. In another example, web application 200 can collect information as part of a pre- or post-approval study.

Pre-approval study database 202 comprises one or more databases stored at one or more computing devices. Pre-approval study database 202 stores data related to a pre-approval study of a medical therapy. Pre-approval study database 202 can store various types of data related to the pre-approval study. For example, pre-approval study database 202 can store data regarding side-effects, dosages, durations of treatments, demographic information of participants, information about people and healthcare sites conducting or involved with the pre-approval study, and other information related to the pre-approval study.

Pre-approval study database 202 can provide some or all of the data related to the pre-approval study to integration system 106. Integration system 106 can modify the patient-centric records of participants in the pre-approval study based on the data from pre-approval study database 202. Furthermore, integration system 106 can modify the patient-centric records of the pre-approval study participants based on post-approval data from other ones of data sources 104. In this way, the patient-centric records of the pre-approval study participants can include data from the pre- and post-approval periods for the therapy.

Insurance claims database 204 comprises one or more databases stored at one or more computing devices. Insurance claims database 204 stores data regarding insurance claims filed by patients in population 102. For example, insurance claims database 204 can store data that provides details regarding a claim filed by a given patient against his or her insurer. Insurance claims database 204 can be implemented in various ways. For example, insurance claims database 204 can be implemented as one or more databases stored in one or more computer readable media.

Device telemetry database 206 comprises one or more databases stored at one or more computing devices. Device telemetry database 206 receives data regarding patients from patients' medical devices and provides this data to integration system 106. Device telemetry database 206 may include a local monitoring device that receives information from a medical device. The local monitoring device transmits some or all of this data via a network to a remote monitoring system. The remote monitoring system stores the data into device telemetry database 206. For example, each of the patients in sub-population 112A can have an implanted pacemaker. In this example, a patient's pacemaker wirelessly relays data regarding the patient to a local monitoring device that is located in the patient's vicinity. The local monitoring device relays the data to a remote monitoring device that stores the data to device telemetry database 206. In this example, the data can include a log of alarm conditions, a log of therapy events, device identification information, and other information regarding the patient.

Device registry database 208 comprises one or more databases stored at one or more computing devices. When a medical device is provided to a patient in population 102, data is entered into device registry database 208. The data entered into device registry database 208 can include information regarding the medical device, such as a model and serial number of the medical device. In addition, the data entered into device registry database 208 can include contact information for the patient, information regarding who provided the medical device to the patient, information regarding a location at which the medical device was provided to the patient, information regarding a time and date at which the medical device was provided to the patient, notes regarding reasons why the medical device was provided to the patient, notes regarding a process of providing the medical device to the patient, and other information regarding the patient. In some instances, the data may be entered into device registry database 208 as part of a program run by an organization that markets the medical device. In other instances, the data may be entered into device registry database 208 as part of a state-mandated program.

EMR system 210 comprises one or more computing devices that provide for storage, retrieval, and modification of electronic medical records. An electronic medical record is a computerized medical record. The electronic medical records include electronic medical records for some or all of the patients in population 102. For example, EMR system 210 can provide for storage, retrieval, and modification of electronic medical records for patients who have received therapies at a given healthcare site. EMR system 210 can provide at least some data stored in the electronic medical records to integration system 106.

In some instances, one or more EMR systems, such as EMR system 210, can provide data to an intermediate system. The intermediate system can provide the data from EMR system 210 to integration system 106. In other instances, the intermediate system can provide data from EMR system 210 to a data warehouse that provides the data to integration system 106. Example intermediate systems include a healthcare connectivity system provided by ApeniMED of Minneapolis, Minn., an Amalga healthcare connectivity system provided by Microsoft Corp. of Redmond, Wash., and a Surescripts healthcare connectivity system provided by Surescripts of Arlington, Va.

Physicians or other healthcare providers enter standard-of-care information regarding patients into EMR system 210. The standard-of-care information includes information collected during routine patient visits or consultations. For example, the standard-of-care information can include blood pressure, pulse rate, respiration rates, symptom complaints, mortality, and other types of routinely collected information. The standard-of-care information entered into EMR system 210 is typically not entered as part of a pre- or post-approval study of a medical therapy. EMR system 210 can provide such standard-of-care information to integration system 106. In other words, the data received by integration system 106 from EMR system 210 can be limited to the standard-of-care information regarding patients in population 102.

Access system 109 can provide data in one or more of patient-centric records 114 to EMR system 210. For example, EMR system 210 may store data regarding services provided to a given patient by a particular hospital. In this example, the patient-centric record for the given patient can include data regarding services provided by another healthcare site. In this example, access system 109 can, with the consent of the given patient, provide data to EMR system 210 regarding the services provided to the given patient by the other healthcare site. In this way, EMR system 210 can store more complete data regarding the given patient.

First post-approval registry 212 comprises one or more databases stored by one or more computing devices. First post-approval registry 212 store data related to a post-approval study of a given medical therapy. An organization can conduct the post-approval study after the organization has received approval to market the given medical therapy. The post-approval study tracks the outcomes of the given medical therapy on patients who participate in the post-approval study. The participating patients may be compensated for their participation. Typically, the participating patients are periodically asked detailed sets of questions. These questions may be designed to determine the long term outcomes of the given therapy on the participating patients. Data based on answers to the sets of questions may be entered into first post-approval registry 212. The participating patients may also be required to provide physiological parameters, such as blood pressure readings, and to provide biological samples. Data based on the physiological parameters and biological samples may be entered into first post-approval registry 212.

Second post-approval registry 214 comprises one or more databases stored by one or more computing devices. Second post-approval registry 214 stores data regarding a different post-approval study that may be different from the post-approval study associated with first post-approval registry 212. For example, first post-approval registry 212 can store data related to a post-approval study of an implanted drug pump and second post-approval registry 214 can store data collected during a post-approval study of a cardiac stent. Because the example set of data sources 104 shown in FIG. 2 includes the first post-approval registry 212 and second post-approval registry 214, patient-centric records 104 for people participating in both the post-approval studies can include data based on both the post-approval studies.

Automated call center 216 comprises computing devices that make telephone calls to patients and collect information from these patients without the involvement of a human call center technician. In some instances, automated call center 216 can collect information from the patients by receiving voice input or receiving touch-tone keypad input. Automated call center 216 can provide some or all data collected during the telephone calls to aggregation system 106.

EHR system 218 comprises one or more databases stored by one or more computing devices. EHR system 218 can store electronic health records for some or all patients in population 102. A patient's electronic health record is an electronic record that contains data regarding the patient's health. EHR system 218 can provide some or all data in the patient's electronic health records to aggregation system 106.

Personal health record system 220 comprises one or more databases stored by one or more computing devices. Personal health record system 220 can store personal health records for some or all patients in population 102. A patient's personal health record can be a health record where health data is created and/or curated by the patient. Personal health record system 220 can provide some or all data entered into the patient's personal health record to aggregation system 106.

External registry 222 comprises one or more databases stored by one or more computing devices. External registry 222 stores data generated by one or more parties other than patients in population 102 and organization that markets a therapy. For example, external registry 222 can be the Social Security death index. The Social Security death index is a database that stores records indicating people in the United States who are deceased. The Social Security death index is provided by the United States government to ensure that people do not claim Social Security benefits by pretending to be people who are deceased. In another example, external registry 222 can be a registry for certain type of disease. For instance, external registry 222 can be a nationwide cancer registry.

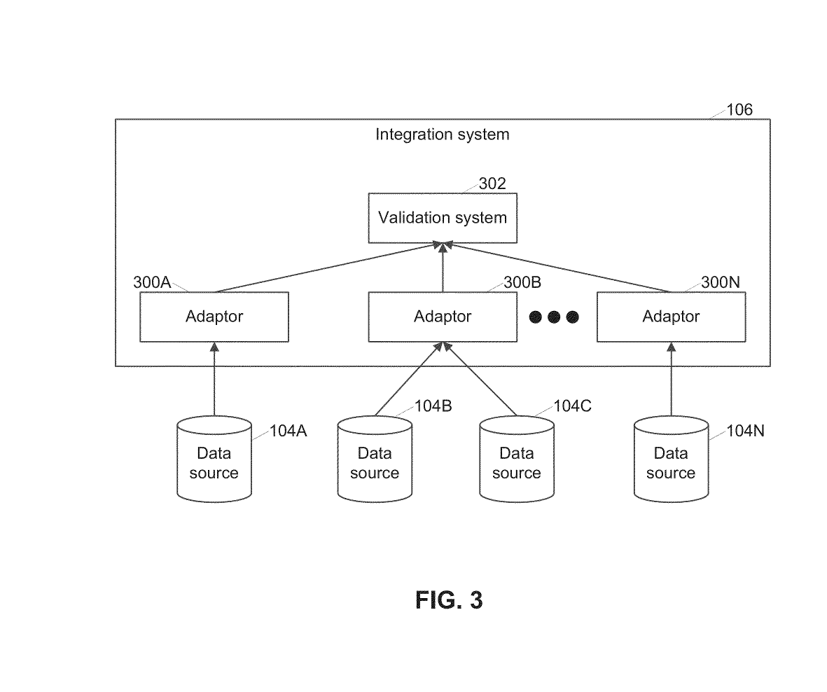

FIG. 3 is a block diagram that illustrates example components of integration system 106. As illustrated in the example of FIG. 3, integration system 106 comprises adaptors 300A through 300N (collectively, “adaptors 300”) and a validation system 302.

Each of adaptors 300 receives data from one or more of data sources 104. For example, adaptor 300A can receive data from data source 104A, adaptor 300B can receive data from data sources 104B and 104C, and adaptor 300N can receive data from data source 104N.

Adaptors 300 adapt or transform data from data sources 104 such that the data can be stored in patient-centric records 114. For example, data from data source 104A can be formatted as an XML document and each of patient-centric records 114 can comprise a set of records in a relational database. In this example, adaptor 300A can adapt the XML document into a set of records that conforms to a schema of the relational database.

After adaptors 300 adapt the data, validation system 302 validates the adapted data before the adapted data is added to patient-centric records 114 in data warehouse 108. If validation system 302 successfully validates the adapted data, validation system 302 adds the validated data to one or more patient-centric records 114 in data warehouse 108. Otherwise, if validation system 302 does not successfully validate the adapted data, validation system 302 does not add the adapted data to patient-centric records 114 in data warehouse 108.

Validation system 302 can validate the adapted data in various ways. For example, validation system 302 can determine whether the adapted data is realistic in view of data already stored in data warehouse 108. In this example, the adapted data can indicate that a given patient's body weight is 250 pounds and data already stored in data warehouse 108 can indicate that the given patient's body weight was 125 pounds one week ago. In this example, validation system 302 can determine that the adapted data is not valid and prevent the adapted data from being entered into data warehouse 108. In another example, validation system 302 can determine whether the adapted data has a correct data format or properly conforms to a schema used in data warehouse 108.

In yet another example, validation system 302 can determine whether data received from data sources 104 is already stored in one or more of patient-centric records 114. Validation system 302 does not add such duplicate data to patient-centric records 114. Integration system 106 can receive duplicate data for various reasons. For example, data source 104A can provide data from a first healthcare site and data source 104B can provide data from a second healthcare site. In this example, the first healthcare site and the second healthcare site can both participate in a health information exchange. As a result, the first healthcare site can store duplicates of records generated at the second healthcare site, and vice versa. Consequently, data source 104A and data source 104B can provide the duplicate records to integration system 106.

Adaptors 300 can be installed in integration system 106 after deployment of integration system 106. In this way, integration system 106 can be updated to receive data from later-added data sources.

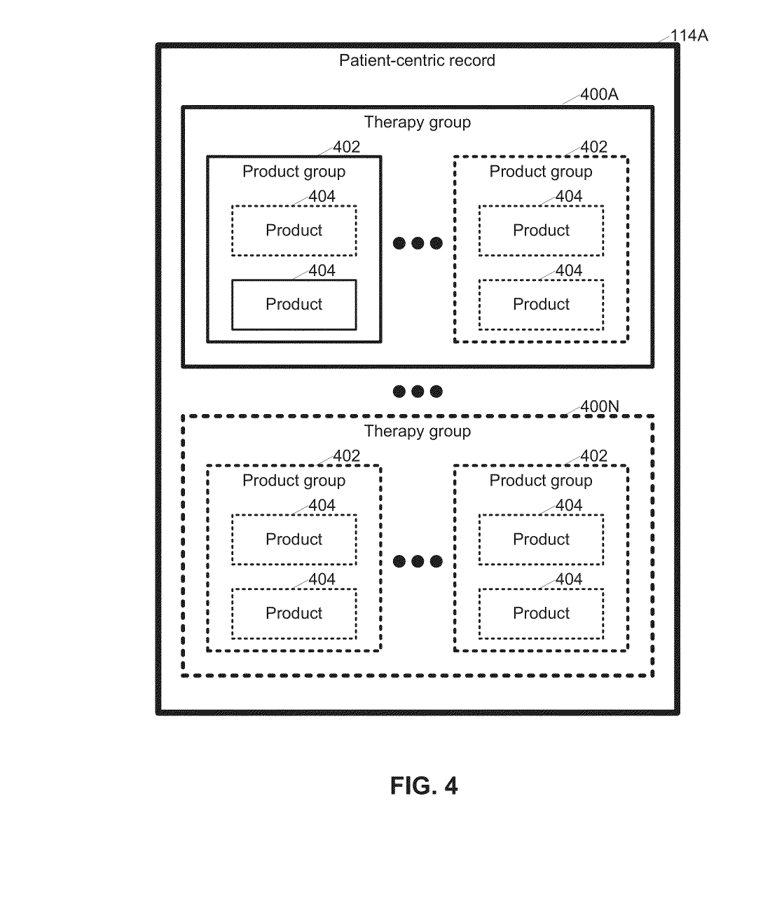

FIG. 4 is a block diagram that illustrates example components of patient-centric record 114A. In some instances, other ones of records 114 also include components similar to those shown in the example of FIG. 4.

Patient-centric record 114A conforms to a schema. The schema defines the allowable content of patient-centric record 114A. In the example of FIG. 4, the schema allows patient-centric record 114A to be linked to one or more therapy group components 400A through 400N (collectively, “therapy group components 400”). Furthermore, the schema allows each of therapy group components 400 to be linked to one or more product group components 402. The schema also allows each of product group components 402 to be linked to one or more product components 404. Therapy group components 400 correspond to categories of therapies. The product group components 402 correspond to narrower categories of therapies.

A component of a patient-centric record can be linked to another component of the patient-centric record in various ways. For example, a component can be linked to another component when the component contains the other component. In another example, a component can be linked to another component when the component contains a reference to the other component. In this example, the reference can be a memory pointer, a Uniform Resource Identifier (URI), a file name path, or another type of data that identifies the other component. In yet another example, a first component and a second component are records in different tables of a database. In this example, the first component can be linked to the second component when the first component specifies a key value of the second component.

Each of therapy group components 400 provides data regarding a different group of therapies. For example, therapy group component 400A can contain data regarding implanted devices that actively deliver therapies, therapy group component 400B can contain data regarding implanted devices that do not actively deliver therapies, and another therapy group component (not shown in the example of FIG. 4) can contain data regarding non-implanted devices.

Product group components 402 linked to each therapy group provide data regarding different product groups in the therapy group. For example, therapy group component 400A can provide data regarding implanted devices that actively deliver therapies. Implanted devices that actively deliver therapies are typically programmable or controllable devices. In this example, product group components 402 linked to therapy group component 400A contain data regarding different groups of implanted devices that actively deliver therapies. For instance, one of product group components 402 linked to therapy group component 400A can contain data regarding drug infusion pumps, another one of product group components 402 linked to therapy group component 400A can contain data regarding electrical stimulation devices. In another example, therapy group component 400N can provide data regarding implanted devices that do not actively deliver therapies. Implanted device that do not actively deliver therapies are typically not programmable or controllable after implantation. In this example, product group components 402 linked to therapy group component 400N contain data regarding different groups of implanted devices that do not actively deliver therapies. For instance, one of product group components 402 linked to therapy group component 400N can contain data regarding stent devices, another one of product group components 402 linked to therapy group component 400N can contain data regarding spinal implant devices, and so on.

Product components 404 linked to each product group provide data regarding different products within the product group. For example, therapy group component 400A can contain data regarding implanted devices that actively deliver therapies and a product group component 402 linked to therapy group component 400A can include data regarding drug infusion pumps. In this example, product components 404 linked to the product group component can include data regarding different models of a drug infusion pump.

Patient-centric records 114 typically are not linked to all of the therapy group components 400 allowed by the schema. Rather, in some embodiments, each of patient-centric records 114 is linked to only those ones of therapy group components 400 needed to store data applicable to the corresponding patient. For example, if a patient has an implanted stimulator and a spinal implant, a patient-centric record for that particular patient may be linked to those particular therapy group components 400. Likewise, therapy group components 400 typically are not linked to all product group components 402 allowed by the schema. Product group components 402 typically are not linked to all of product components 404 allowed by the schema. Rather, each of therapy group components 400 is linked only to those ones of product group components 402 needed to store data applicable to the corresponding patient. Each of product group components 402 is linked only to those ones of product components 404 needed to store data applicable to the corresponding patient.

The example of FIG. 4 uses solid lines to indicate ones of therapy group components 400, product group components 402, and product components 404 that are present in patient-centric record 114A. The example of FIG. 4 uses dashed lines to indicate ones of therapy group components 400, product group components 402, and product components 404 that are not present in patient-centric record 114A.

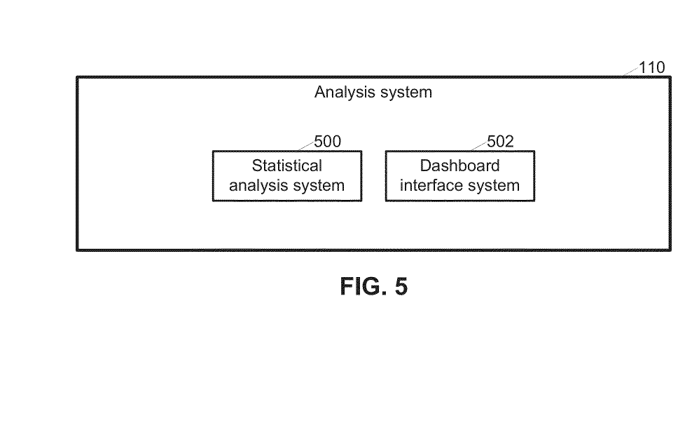

FIG. 5 is a block diagram that illustrates example details of analysis system 110. As illustrated in the example of FIG. 5, analysis system 110 comprises a statistical analysis system 500 and a dashboard interface system 502. Readers will understand that FIG. 5 and its accompanying description are not applicable to all instances. For instance, analysis system 110 can include components in addition to, fewer than, or different from those shown in the example of FIG. 5.

Statistical analysis system 500 uses access system 109 to extract data from data warehouse 108. Statistical analysis system 500 uses the extracted data to perform statistical analyses of the data. Statistical analysis system 500 can use the extracted data to perform various types of statistical analyses for various purposes. For example, statistical analysis system 500 can use the extracted data to determine whether patients who have received therapies in a certain category are more or less likely than people in the general population to have a given type of health event. In this example, the health event may be a favorable health event or an adverse health event.

Dashboard interface system 502 uses access system 109 to extract data from data warehouse 108. Dashboard interface system 502 uses the extracted data to generate output data that summarizes data in data warehouse 108. In addition, dashboard interface system 502 uses the output data to provide one or more dashboard interfaces. Each of the dashboard interfaces present summarized versions of the data currently in data warehouse 108. Different ones of the dashboard interfaces present data relevant to different audiences. For example, the dashboard interfaces can contain summary data relevant to individual caregivers, such as physicians or nurses. Other dashboard interfaces can contain summary data relevant to health care sites, such as hospital systems, hospitals, clinics, and doctors' offices. For example, dashboard interface system 502 can use the data in patient-centric records 114 to generate output data that summarizes outcomes of therapies on patients treated at a particular healthcare site. Furthermore, in this example, dashboard interface system 502 can also or alternatively use the data of patient-centric records 114 to generate output data that summarizes outcomes of therapies on patients treated at healthcare sites other than the particular healthcare site. For instance, dashboard interface system 502 can output data that compares outcomes of patients treated at the particular healthcare site with outcomes of patients treated at one or more other healthcare sites. Yet other dashboard interfaces can contain summary data relevant to marketers of medical devices or pharmaceuticals. Yet other dashboard interfaces can contain summary data relevant to individual patients. Yet other dashboard interfaces can contain summary data relevant to governmental organizations or regulatory organizations, such as the FDA.

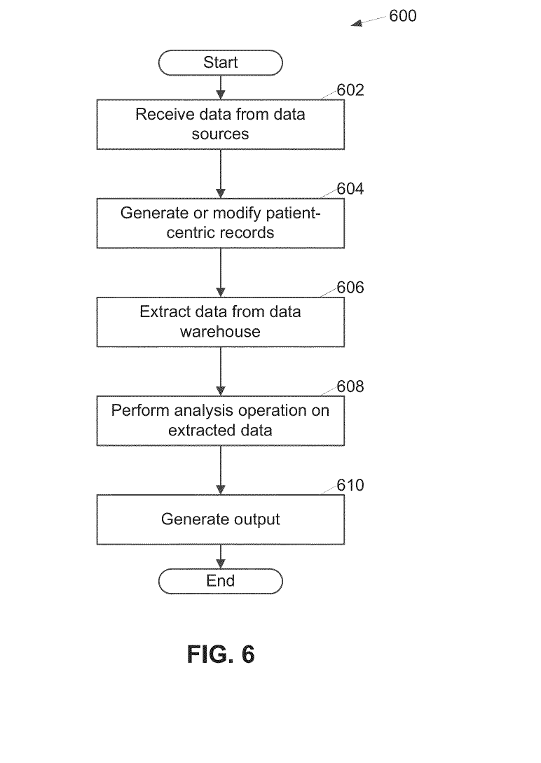

FIG. 6 is a flowchart of an example operation 600 in which patient-centric records are used to analyze post-approval medical therapies. After operation 600 starts, integration system 106 receives data from the data sources 104 (602). Integration system 106 can receive data from data sources 104 in various ways. For example, integration system 106 can selectively extract data from one or more of data sources 104 by issuing queries on data sources 104. In another example, integration system 106 can copy data in the whole from one or more of data sources 104. In yet another example, one or more of the data sources 104 can send data to integration system 106 without integration system 106 first requesting the data from the data sources 104.

In some instances, integration system 106 receives data from one or more of data sources 104 on an on-going basis. For example, a hospital can frequently add new data to EMR system 210. In this example, integration system 106 can receive the new data from EMR system 210 on an on-going basis. For instance, integration system 106 can receive the new data from EMR system 210 as the new data is added to EMR system 210 or in batches on a periodic basis.

In some instances, integration system 106 receives data from one or more of the data sources 104 only once. For example, after a pre-approval study is complete, no additional data is added to pre-approval study database 202. In this example, integration system 106 does not receive data from pre-approval study database 202 on an on-going basis. Rather, in this example, integration system 106 only receives data from pre-approval study database 202 once.

When integration system 106 receives data from one or more of data sources 104, integration system 106 generates or modifies patient-centric records 114 to include patient data based on the data (604). As described elsewhere in this disclosure, integration system 106 can adapt or transform the data from data sources 104. Furthermore, integration system 106 can validate data before generating a patient-centric record that contains the data or before modifying an existing one of patient-centric records 114 to include the data.

Next, access system 109 extracts data from data warehouse 108 (606). Access system 109 can extract data from data warehouse 108 in various ways. For example, access system 109 can extract data from data warehouse 108 by issuing search queries against data warehouse 108. In this example, the search queries are structured using the schema of patient-centric records 114. For instance, the search queries can be structured to extract data based on values specified by a therapy group component, a product group component, or a product component. Because the search queries are structured using the schema of patient-centric records 114, it may be unnecessary for analysts to prepare search queries to extract similar data from data sources 104.

The search queries can be formatted in various ways. For example, the search queries can be formatted as SQL queries. In another example, the search queries can belong to another query language, such as Advanced Query Syntax (AQS). In yet another example, the search queries can be structured queries or free text queries.

Access system 109 can extract various types of data from patient-centric records 114 in data warehouse 108. For example, access system 109 can extract data regarding particular patients in population 102. For instance, in this example, access system 109 can extract data regarding multiple therapies received by a single given patient. In another example, access system 109 can extract data regarding therapies in a product group. For instance, in this example, access system 109 can extract data regarding patients who have received any of the implanted drug pumps in a given product group. In yet another example, access system 109 can extract data from across a therapy group. For instance, a given therapy group can correspond to the implanted medical devices marketed by a given organization. In this example, access system 109 can extract data regarding each patient in population 102 who has received an implanted medical device marketed by the given organization.

Analysis system 110 then performs an analysis operation on the extracted data (608). As described elsewhere in this disclosure, analysis system 110 can perform various types of analysis operations on the extracted data. For example, dashboard interface system 502 in analysis system 110 can perform an analysis operation that generates summary data.

Analysis system 110 generates output data 116 (610). Output data 116 contains results of the analysis operations performed on the extracted data. In various embodiments, the output data 116 can have various forms. For example, dashboard interface system 502 can output Hypertext Markup Language (HTML) data that represents a dashboard interface containing the summary data. In another example, statistical analysis system 500 can generate output data 116 that indicates rates of a given health event in patients receiving a therapy. In yet another example, statistical analysis system 500 can generate output data 116 that indicates probabilities of a given therapy being successful.

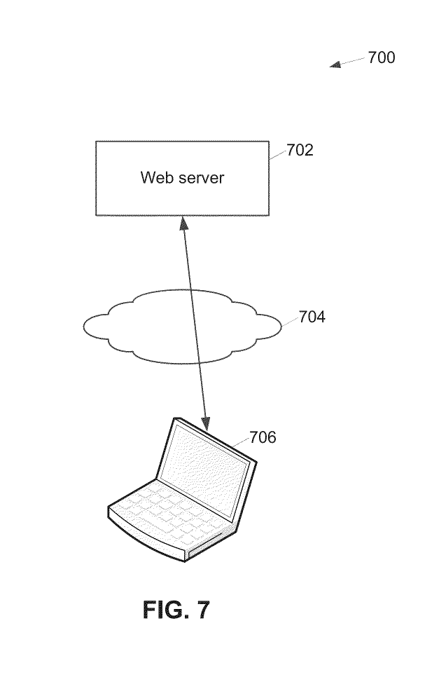

FIG. 7 is a block diagram that illustrates an example data source 700. In some embodiments, the data sources 104 in the system 100 include data source 700. As illustrated in the example of FIG. 7, data source 700 comprises a web server 702, a communication medium 704, and a client device 706.

Web server 702 and client device 706 each comprise one or more computing devices. Although the example of FIG. 7 shows client device 706 as a laptop computer, readers will understand that client device 706 can be another type of computing device, such as a desktop computer, a tablet computer, a smartphone, or another type of computing device.

Communication medium 704 facilitates communication between web server 702 and client device 706. In various embodiments, communication medium 704 facilitates communication between web server 702 and client device 706 in various ways. For example, communication medium 704 can comprise a computer network, such as the Internet and/or a local area network. In another example, communication medium 704 can be a wired or wireless communication link, such as a USB cable or a WiFi connection.

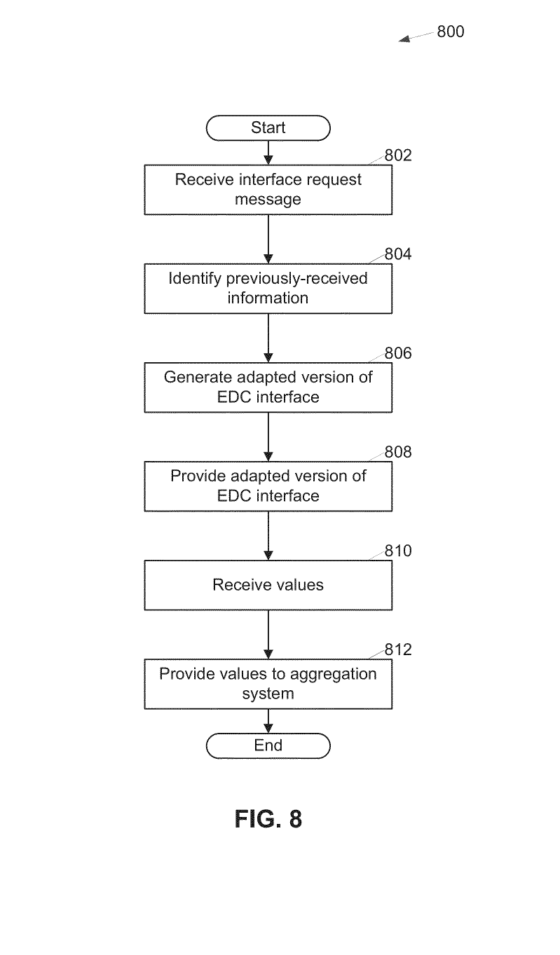

FIG. 8 is a flowchart illustrating an example operation 800 of data source 700 in which an EDC interface is adapted based on data of patient-centric records. After the operation 800 starts, web server 702 in data source 700 receives an interface request message from client device 706 via communication medium 704 (802). The interface request message requests an EDC interface for use in inputting information regarding a given patient.

The interface request message can be formatted in various ways. For example, the interface request message comprises one or more Hypertext Transfer Protocol Security (HTTPS) request messages. In another example, the interface request message can comprise one or more remote procedure invocation messages.

After receiving the interface request message, web server 702 identifies previously-received information for the given patient (804). The patient-centric record corresponding to the given patient provides the previously-received information for the given patient. For example, the given patient's patient-centric record can provide data received from EMR system 210. In this example, web server 702 can identify the data received from EMR system 210 as previously-received data for the given patient.

After identifying the previously-received information for the given patient, web server 702 generates an adapted version of the EDC interface (806). The EDC interface is associated with a default set of data entry features. The adapted version of the EDC interface includes some or all data entry features in the default set of data entry features. The data entry features in the adapted version of the EDC interface receive entry of data that is not already stored in data warehouse 108. The adapted version of the EDC interface does include data entry features that receive entry of data that is already stored in data warehouse 108. For example, a data entry feature in the EDC interface can be disabled when the data typically received by the data entry feature has previously been received. In another example, a data entry feature is not present or hidden in the EDC interface when the data typically received by the data entry feature has previously been received. In yet another example, web server 702 can cause pieces of previously-received data to be pre-populated into one or more data entry features of the EDC interface associated with the pieces of previously-received data. In other words, web server 702 can generate the adapted version of the EDC interface such that data entry features of the EDC interface include one or more data entry features that are pre-populated with data already stored in patient-centric records 114. In some instances, a user can modify the data that was pre-populated into the data entry features. In this way, users can save time and effort because the adapted version of the EDC interface does not prompt users to enter data that has previously been received.

Web server 702 provides the adapted version of the EDC interface to client device 706 (808). Web server 702 can provide the adapted version of the EDC interface to client device 706 in various ways. For example, web server 702 can generate one or more HTTP response messages containing data representing the adapted version of the EDC interface. In this example, web server 702 sends the one or more HTTP response messages to client device 706 over communication medium 704.

Subsequently, web server 702 receives values entered into the data entry features of the EDC interface from client device 706 (810). Web server 702 then provides the values to integration system 106 (812). In this way, data source 700 provides data regarding the given patient to integration system 106.

FIG. 9 is a block diagram of an example computing device 900. Computing device 900 is a physical device that processes information. In some embodiments, the data sources 104, integration system 106, data warehouse 108, access system 109, and analysis system 110 are provided by one or more computing devices similar to computing device 900.

Computing device 900 comprises a data storage system 902, a memory 904, a secondary storage system 906, a processing system 908, an input interface 910, a display interface 912, a communication interface 914, and one or more communication media 916. The communication media 916 enable data communication between processing system 908, the input interface 910, the display interface 912, the communication interface 914, memory 904, and secondary storage system 906. Readers will understand that computing device 900 can include components in addition to those shown in the example of FIG. 9. Furthermore, readers will understand that some computing devices do not include all of the components shown in the example of FIG. 9.

A computer-readable medium is a medium from which processing system 908 can read data. Computer-readable media include computer storage media and communications media. Computer storage media include physical devices that store data for subsequent retrieval. Computer storage media are not transitory. For instance, computer storage media do not exclusively comprise propagated signals. Computer storage media include volatile storage media and non-volatile storage media. Example types of computer storage media include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media include media over which one device can communicate data to another device. Example types of communication media include communication networks, communications cables, wireless communication links, communication buses, and other media over which one device is able to communicate data to another device.

Data storage system 902 is a system that stores data for subsequent retrieval. In the example of FIG. 9, data storage system 902 comprises memory 904 and secondary storage system 906. Memory 904 and secondary storage system 906 store data for later retrieval. In the example of FIG. 9, memory 904 stores computer-executable instructions 918 and program data 920. Secondary storage system 906 stores computer-executable instructions 922 and program data 924. Physically, memory 904 and secondary storage system 906 each comprise one or more computer storage media.

Processing system 908 is coupled to data storage system 902. Processing system 908 reads computer-executable instructions from the data storage system 902 and executes the computer-executable instructions. Execution of the computer-executable instructions by processing system 908 causes computing device 900 to perform the actions indicated by the computer-executable instructions. For example, execution of the computer-executable instructions by processing system 908 can cause computing device 900 to provide Basic Input/Output Systems, operating systems, system programs, application programs, or can cause computing device 900 to provide other functionality.

Processing system 908 reads the computer-executable instructions from one or more computer-readable media. For example, processing system 908 can read and execute computer-executable instructions 918 and 922 stored on memory 904 and secondary storage system 906. In some embodiments, computing device 900 can provide data sources 104, integration system 106, data warehouse 108, access system 109, and/or analysis system 110 when processing system 908 executes computer-executable instructions 918 and/or computer-executable instructions 922.

Processing system 908 comprises one or more processing units 926. Processing units 926 comprise physical devices that execute computer-executable instructions. In various embodiments, processing units 926 can comprise various types of physical devices that execute computer-executable instructions. For example, one or more of processing units 926 can comprise a microprocessor, a processing core within a microprocessor, a digital signal processor, a graphics processing unit, or another type of physical device that executes computer-executable instructions.

Input interface 910 enables computing device 900 to receive input from an input device 928. Input device 928 comprises a device that receives input from a user. In various embodiments, input device 928 comprises various types of devices that receive input from users. For example, input device 928 can comprise a keyboard, a touch screen, a mouse, a microphone, a keypad, a joystick, a brain-computer interface device, or another type of device that receives input from a user. In some embodiments, input device 928 is integrated into a housing of computing device 900. In other embodiments, input device 928 is outside a housing of computing device 900.

Display interface 912 enables computing device 900 to display output on a display device 930. Display device 930 is a device that displays output. Example types of display devices include monitors, touch screens, display screens, televisions, and other types of devices that display output. In some embodiments, display device 930 is integrated into a housing of computing device 900. In other embodiments, display device 930 is outside a housing of computing device 900.

Communication interface 914 enables computing device 900 to send and receive data over one or more communication media. In various embodiments, communication interface 914 comprises various types of devices. For example, communication interface 914 can comprise a Network Interface Card (NIC), a wireless network adapter, a Universal Serial Bus (USB) port, or another type of device that enables computing device 900 to send and receive data over one or more communication media.

FIG. 10 is a flowchart illustrating exemplary techniques 1000 for modeling, with a computing device, a distribution of post-therapy outcomes in a population based on a distribution of the post-therapy outcomes in a subset of the population. As one example, the methods described in this disclosure may be used to modify the distribution of the post-therapy outcomes in a subset of the population based on a comparison of the distributions of baseline characteristics for the population as a whole and the subset of the population.

A computing device used to model the distribution of the post-therapy outcomes accesses a data storage system to obtain baseline characteristics for a population of patients who each receive a medical therapy, baseline characteristics and information regarding one or more post-therapy outcomes for a subset of the population of patients and an indication of an association between at least one aspect of the baseline characteristics and at least one of the post-therapy outcomes in the subset of the population. As referred to herein, a post-therapy outcome is a patient characteristic that is observed following the onset of a medical therapy. When a population of patients is analyzed, generally the medical therapy is considered to be associated with the distribution of post-therapy outcomes in the population, i.e., there is a causal relationship between the distribution of the post-therapy outcomes in the population and the medical therapy received by the patients in the population. An analysis of post-therapy outcomes may include any number of related or unrelated post-therapy outcomes, each of which may be associated either individually or collectively with any number of baseline characteristics.

Although the techniques disclosed herein rely on patient data from a plurality of individual patients, the patient data including the baseline characteristic information and the post-therapy outcome data will generally be derived from individual patient records. In different examples, the computing device may aggregate individual patient records in order to model the distribution of post-therapy outcomes in the patient population or the computing device may access aggregate patient data on the data storage system.

As described in further detail below, a computing device models a distribution of the at least one post-therapy outcome in the population based on a distribution of the at least one post-therapy outcome in the subset of the population and further based on a comparison of a distribution of the at least one aspect of the baseline characteristics in the subset of the population with a distribution of the at least one aspect of the baseline characteristics in the population. These techniques require baseline characteristics for at least part of the population distinct from the study population, i.e., information in addition to the information regarding the subset of the population. In some examples, the baseline information may be available for the entire population; in other examples, the baseline information may be available only for a portion of the population outside the study population. The baseline information (complete or partial) may be used to model the distribution of the post-therapy outcomes for the individuals for which the baseline information applies. In some instances, imputation may be used to replace missing baseline information, and imputed baseline information values used in modeling the distribution of the post-therapy outcomes.

As referred to in this disclosure, baseline characteristics may include information known or knowable prior to a medical therapy or other intervention that is to be studied. When the intervention is a medical therapy, for example, the baseline characteristics include information, such as patient or therapy characteristics, known or knowable prior to the initiation of the medical therapy.

In the specific example of a post-approval study, all participants in the study may receive the same or similar treatment. Generally, to extend the effect of the treatment observed by patients in the study to the entire patient population receiving the same treatment, the patients in the study should be a representative sample of the patients in the entire population receiving the same treatment. However, for reasons of convenience, or efficient statistical modeling, it is not always true that the patients in the study are representative of the entire population receiving the same treatment. The disclosed techniques provide a means for modeling the distribution of post-therapy outcomes in a population of patients based on a distribution of the post-therapy outcomes in a subset of the population, even when the distribution of baseline characteristics in the subset of the population are not representative of the distribution of baseline characteristics in the entire patient population.

As one example, if a post-approval study is designed to determine whether obese patients experience different outcomes after the therapy, referred to as therapy outcomes, than people who are not obese, then the post-approval study should include a significantly large number of obese patients. Depending on the size of the post-approval study, it may be desirable to include a higher proportion of obese patients in the study than in the general population of patients receiving the medical therapy. The distribution of outcomes of patients in such a study would not be applicable to the general population, however, at least because the participants in the study would not be representative of the entire population of patients receiving the medical therapy due to the relatively high proportion of obese patients in the post-approval study as compared to the entire population of patients receiving the same medical therapy.

The techniques disclosed herein may be used to account for important differences in a population subset, such as the relatively small number of patients in a post-approval study, as compared to the entire population of patients receiving the medical therapy. More specifically, the distribution of baseline characteristics of a population subset, such as the proportion of obese patients, may be compared with the distribution of baseline characteristics in the entire patient population. Based on this comparison, the therapy outcomes, e.g., the distribution of outcomes for obese and non-obese patients, in the population subset may be modified according to the baseline characteristics of the entire patient population in order to model the distribution of outcomes for the entire patient population. Note that such techniques may utilize some information regarding the distribution of baseline characteristics for the entire population, i.e., information in addition to the information regarding the subset of the population, the subset of the population being the patients participating in the study.

It is observed that even if the distribution of baseline characteristics in the subset of the population are not representative of the distribution of baseline characteristics in the entire population receiving the medical therapy, modifying of the modeled distribution of therapy outcomes in the subset may only be useful if there is an association between the baseline characteristics and the distribution of therapy outcomes. In the example of obese patients above, if being obese has no effect on the distribution of a therapy outcome, than modifying the modeled distribution of the therapy outcomes observed in the study to account for the overrepresentation of obese patients in the study would not be expected to significantly alter the distribution of therapy outcomes modeled for the entire population of patients receiving the same medical therapy.

Different examples of baseline characteristics may be associated with a distribution of therapy outcomes. For various reasons, it may be difficult to accurately extrapolate the results of medical studies to a broader population of patients. For example, patients in a medical study, such as a post-approval study, who receive the therapy may be cared for by very experienced physicians while patients outside the study who receive the therapy may be treated by only moderately experienced physicians. In this example, the patients outside the study may have different outcomes than the patients who participate in the study. Furthermore, it may be difficult for investigators to apply the distribution of therapy outcomes in the study of one specific medical therapy to other categorically-similar therapies.

When studying a population of patients given a medical therapy, care is taken to ensure the effects of the study itself can be distinguished from the effects of the medical therapy. As one example, randomization of treatment assignment to patients in the study may be used to argue that any difference between treatment groups before administering treatment is not systematic, but is due to chance alone. As another example, double blinding (blinding of both the person administering/measuring the treatment and of the person receiving the treatment) is often used to minimize the possibility of biased responses to treatment. Such steps are taken to provide confidence that the observed difference in the effect of the interventions examined within the study can be ascribed in a causal fashion to the different interventions administered. However, with a post-approval study, all participants in the study may be receiving the treatment.

Some additional consideration may be taken into how to select the persons receiving the interventions within the study. These efforts are usually motivated either by a desire to ensure that the persons receiving the interventions are representative of the parent population as a whole or by an interest in identifying a segment of the parent population in whom the effects of the interventions can be measured with a minimum of distortion. Related efforts have also been made into selection of the persons administering the interventions under study.

These approaches are essentially geared towards creating a situation where any systematic differences in the treatment administration groups under consideration in the study are balanced, so that they cancel out when differences in treatment administration are assessed. In addition to balance, one can also adjust for differences in measured characteristics through statistical modeling, which parameterizes the relationships between these characteristics and the response variable(s) being measured within the study.

The techniques described in this disclosure may serve to create favorable settings for measuring the difference in effects of interventions, such as medical therapies, within a study population, to improve the ability to estimate the difference in effects of interventions within a study population, or to strengthen the logical foundation for claiming that the difference in effects of interventions observed within a study population can be extended to the entire parent population, as referred to herein, the parent population is the group for which the studied population is intended to be representative.

In addition, this disclosure provides techniques by which the estimated difference in effects of interventions observed within a study population may be explicitly modified to reflect discrepancies between the study population and the parent population. These techniques may focus on the concept of ascertaining the effect of interventions, such as medical therapies, through looking at the difference in effects, but one may also work with a single intervention instead, and look directly at the measured effect of the intervention. Sampling methodology has been used in some settings (notably polling for political opinions) to infer characteristics of a parent population given what is observed in a subset of the population. Generally, sampling methodology is appropriate when the subset sampled can be obtained in a representative or random fashion, and when it is not feasible to get information on the entire parent population.

As discussed above, with medical therapies, such as medical therapies utilizing medical devices, it is often possible to obtain information of various degrees on the entire parent population. Such information may include, e.g., a patient demographic such as a mailing address for the patient, a mailing address for the surgeon who implanted the device and/or the date of birth of the patient (to assist in uniquely identifying the patient). Even though all patients in a population receiving a medical therapy are not monitored over time (so that one or more therapy outcomes are not measured), these baseline characteristics may be used to determine how certain baseline characteristics of the parent population differed from the study population, and then calibrate and modify the estimate from the study population to reflect accurately the composition of the entire parent population.

The techniques 1000 of FIG. 10 facilitate calibration of therapy outcomes from a study population to reflect accurately the composition of the entire parent population. As one example, the techniques of FIG. 10 may be performed by statistical analysis system 500 (FIG. 5). The techniques of FIG. 10 may be applied to an operation in which patient-centric records are used to analyze post-approval medical therapies, for example, as discussed previously with respect to FIG. 6. Accordingly, the techniques of FIG. 10 may be performed with computing device such as a computing device incorporating analysis system 110 (FIG. 5). The computing device may process and analyze data stored in a data storage system, such as data relating to baseline characteristics for a population of patients who each receive a medical therapy, baseline characteristics and information regarding one or more post-therapy outcomes for a subset of the population of patients and an indication of an association between at least one aspect of the baseline characteristics and at least one of the post-therapy outcomes in the subset of the population.

First, a computing device accesses a data storage system to obtain data representing baseline characteristics for a population of patients who each receive a medical therapy (1002). The data storage system may include one or more computing devices and electronic data storage media for managing data storage and retrieval. In some examples, the data storage system may include computing devices and electronic data storage media distributed across a network.

Baseline characteristics may include information, such as patient or therapy characteristics, known or knowable prior to the initiation of the medical therapy. In different examples, baseline characteristics may include one or more of the following: patient date of birth, geographic location of the medical therapy, the geographic location of a patient's residence (such as a mailing address), a metric of the skill of a practitioner, such as an implanting surgeon, associated with the delivery of the medical therapy, a metric of the experience of a practitioner associated with the delivery of the medical therapy, a size of a medical facility, such as a hospital or clinic, associated with the delivery of the medical therapy, and/or a metric of the experience of a medical facility associated with the delivery of the medical therapy. Other examples of baseline characteristics may more directly result from the medical therapy itself. As an example, for a device implantation, the techniques used to implant the device, e.g., posterior or anterior approach, or the implant location may represent baseline characteristics.

Baseline characteristics may also include patient histories, such as patient medical histories, physical characteristics, race, gender, socio-economic status, mental health history, et cetera. These are just examples of baseline characteristics, and any particular baseline characteristic is not germane to this disclosure; these and any number of other examples of baseline characteristics may be used within the spirit of this disclosure. In addition, any combination or interaction of baseline characteristics may be used to recalibrate observed therapy outcomes of a study population in order to model therapy outcomes for the entire population.

The disclosed techniques may also be used with any medical therapy. In one example, the medical therapy may include an electrical stimulation therapy, such as a cardiac stimulation therapy, neurostimulation therapy, a deep brain stimulation therapy, a cochlear stimulation therapy and/or a gastric stimulation therapy, e.g., each of which may be delivered by an implantable electrical stimulator. In some examples, cardiac stimulation therapy may include a cardiac pacing therapy, a cardioversion therapy, and/or a defibrillation therapy. In other examples, the medical therapy may include one or more of the following: a medical lead implantation procedure, a fluid delivery therapy, a glucose monitoring and insulin delivery therapy, a drug therapy, a medical stent implantation procedure, such as a bare metal stent implantation procedure or drug-infused stent implantation procedure, a heart valve implantation procedure, a fixation cage for spinal surgery bone growth implantation procedure, and/or an ablation therapy, such as a cryogenic ablation therapy and/or a radio frequency (RF) ablation therapy. Other examples of medical therapies include pharmaceutical therapies, biologic therapies and a combination thereof. Additionally, the medical therapies may include a placebo or a non-experimental standard of care, e.g., to serve as a control population for a study of a medical therapy.

In addition, any combination or interaction of medical therapies may be modeled according to the techniques disclosed herein. For example, a device implantation may be studied in combination with a drug therapy. As another example, a device implantation may be studied in combination with physical therapy or psychiatric visits. These are just a few examples of medical therapies suitable for modeling according to the techniques disclosed herein. Any particular medical therapy is not germane to this disclosure; these and any number of other examples of medical therapies may be used within the spirit of this disclosure. In addition, any combination or interaction of medical therapies may be used to model therapy outcomes for the entire patient population.

The computing device also accesses baseline characteristics and information regarding one or more post-therapy outcomes for a subset of the population of patients (1004). Generally, the information regarding the post-therapy outcomes represents an effect of the medical therapy, such as a metric of the efficacy of the therapy. In different examples, studied post-therapy outcomes may include a time to first occurrence of an event, such as death, hospitalization, myocardial infarction, stroke, cancer, congestive heart failure, diabetes, depression, addiction, explanation of a medical device used to deliver the medical therapy, a particular adverse event such as death, a category of adverse event such as infections, progression to or remission from a particular disease state, failure of all or part of a device, malfunction of all or part of a device, discharge from hospital stay, improvement in a quality of life metric by some fixed amount, a proportion of patients with a given post therapy outcome at a certain point in time, such as pain score beyond a certain threshold, occurrence of repeat operation or procedure, maximum or minimum test result beyond a certain value, occurrence of a particular adverse event or category of adverse event, or failure or malfunction of all or part of a device, value of a discrete-valued or continuous-valued questionnaire or evaluation from the patient or a clinician, or a continuous valued test result or categorization of the same. In addition, any composite endpoint created by combining two or more of such endpoints, as well as multivariate vectors of any combination of the type of items described above, may also be incorporated into a model representing a distribution of the at least one post-therapy outcome in the population.

Studied post-therapy outcomes may also be distinguished by time. For example, if the studied post-therapy outcomes include death, the time period before and/or after the medical therapy may be used to evaluate the efficacy of the therapy and the data representing the distribution of post-therapy outcomes may include the time a patient died in addition to the indication. In some cases, the time period may be represented by discrete categories, e.g., less than 30 days after the medical therapy, between 30 and 90 days, between 90 days and 6 months, 6 months to 1 year, 1 year to 3 years, 3 years to 5 years, 5 years to 10 years and so on. In other examples, more precise time periods for each patient may be included in the therapy outcome information for the participants of the study.

As another example, a studied post therapy outcome may be a patient characteristic at a certain time after the initiation of the medical therapy. For example, a studied post-therapy may look at the efficacy of the medical therapy at one or more discrete time periods after the initiation of the medical therapy. With a pain therapy, for example, the activity level of a patient, higher activity levels generally known to be associated with lower pain, may be studied at 3 months after the initiation of the pain therapy. Numerous other examples of therapy outcomes exist.

In one example, the post-therapy outcomes information may be collected after the conclusion of the medical therapy, e.g., with one-time medical therapies. In other examples, the post-therapy outcomes information may be collected when the medical therapy was ongoing, e.g., with periodic or continuous medical therapies such as drug therapies, electrical stimulation therapies and/or cardiac stimulation therapies. These are just a few examples of post-therapy outcomes suitable for modeling according to the techniques disclosed herein. Any particular post-therapy outcome is not germane to this disclosure; these and any number of other examples of post-therapy outcomes may be used within the spirit of this disclosure. In addition, any combination or interaction of post-therapy outcomes may also be modeled in accordance with this disclosure.

In addition, the computing device accesses a data storage system storing an indication of an association between at least one aspect of the baseline characteristics and at least one of the post-therapy outcomes in the subset of the population (1006). As referred to herein, an association is any relationship between two characteristics that renders them statistically dependent. In one example, the computing device may analyze the post-therapy outcomes along with baseline characteristics for the subset of the population to find the association between at least one aspect of the baseline characteristics and at least one of the post-therapy outcomes in the subset of the population. In another example, the computing device may access a previously determined indication of the association between at least one aspect of the baseline characteristics and at least one of the post-therapy outcomes in the subset of the population. For example, once the association has been determined, it may not be necessary to analyze updated or new data sets to verify or model a known association.

Using the accessed information, the computing devices models a distribution of the at least one post-therapy outcome in the population based on a distribution of the at least one post-therapy outcome in the subset of the population and further based on a comparison of a distribution of the at least one aspect of the baseline characteristics in the subset of the population with a distribution of the at least one aspect of the baseline characteristics in the population (1008). For example, modeling the distribution of the at least one post-therapy outcome in the population may include comparing the distribution of the at least one aspect of the baseline characteristics in the subset of the population with the distribution of the at least one aspect of the baseline characteristics in the population to facilitate modifying the distribution of the at least one post-therapy outcome in the subset of the population such that it more precisely applies to the entire population. In one specific example, modeling the distribution of the at least one post-therapy outcome in the population includes reweighting the distribution of the at least one post-therapy outcome in the subset of the population according to the relative distribution of the at least one aspect of the baseline characteristics in the subset of the population as compared to the distribution of the at least one aspect of the baseline characteristics in the population to produce the modeled distribution for the at least one post-therapy outcome in the population.

The modeling performed by the computing device may conform to Equation 1, wherein F₁, F₂, F₃, and F₄ represent functions, Y_{P} represents the post-therapy outcomes for the entire patient population, Y_{S} represents the post-therapy outcomes for the subset of the population, X_{P} represents the baseline characteristics for the entire patient population, X_{S} represents the baseline characteristics for the subset of the population:

F₁(Y_{P})=F₄[F₃(Y_{S}),F₂(X_{P},X_{S})] Equation 1

Equation 1 may represent the general relationship between the baseline characteristics and post-therapy outcomes for both the entire patient population and the subset of the population. More specifically, Equation 1 indicates that the distribution of post-therapy outcomes for the entire patient population is dependent on the distribution of post-therapy outcomes for the subset of the population and a comparison between the distribution of baseline characteristics for the entire patient population and the distribution of baseline characteristics for the subset of the population.

Modeling the distribution of the at least one post-therapy outcome in the population may include modifying the distribution of the at least one post-therapy outcome in the subset of the population according to the relative distribution of the at least one aspect of the baseline characteristics in the subset of the population as compared to the distribution of the at least one aspect of the baseline characteristics in the population. For example, the modeled distribution for the at least one post-therapy outcome in the population may be obtained by using the baseline characteristics in the population in the model in place of the baseline characteristics in the subset of the population in the model.

There are numerous suitable techniques in which an estimate from a study population could be calibrated and modified to better reflect the composition of the parent population. Such techniques include, but are not limited to, linear regression, analysis of variance, analysis of covariance, logistic regression, survival analysis, counting process models, generalized linear models, mixed models, nonlinear mixed effect models, generalized linear mixed models, generalized estimating equations, Poisson regression, negative binomial regression, conditional logistic regression, log linear modeling, and weighted variants of the preceding. Both frequentist and Bayesian versions of these methods may be used. Furthermore, updated versions of the estimates obtained in such fashion could be incorporated into approaches such as statistical process control, CUSUM (cumulative sum) charts, likelihood ratio tests and sequential probability ratio tests that are used to monitor how estimates of effects evolve over a time index.

While the described examples generally include evaluation of the mean of a distribution, the techniques disclosed herein may be used to model any of one or more aspects of a distribution including, for example, mean, variance, standard deviation, median, quartiles, quantiles, and cumulative distribution functions. Accordingly, any of these aspects may be represented and calibrated according to baseline information from a parent population.

In the specific example in which the relevant baseline characteristics may be represented as one of two possible values, e.g., “Is a patient dead or alive at 1 year following initiation of the medical therapy?”, modeling the distribution of the at least one post-therapy outcome in the population may include multiplying a prevalence of the at least one of the post-therapy outcome in a proportion of the subset of the population exhibiting the at least one aspect of the baseline characteristics by a proportion of the population exhibiting the at least one aspect of the baseline characteristics to produce a first value, multiplying a prevalence of the at least one of the post-therapy outcomes in the proportion of the subset of the population not exhibiting the at least one aspect of the baseline characteristics by a proportion of the population not exhibiting the at least one aspect of the baseline characteristics to produce a second value, and adding the first value to the second value to produce a modeled prevalence value that represents the modeled distribution for the at least one post-therapy outcome in the population.

As an example in which the relevant baseline characteristics may be represented as one of two possible values, assume the studied therapy outcome is mortality rate within one year of the initiation of a medical therapy, and that the baseline characteristic associated with the therapy outcome is obesity. In this example, the mortality rate for patients in the study may be modified according to the relative proportion of obese patients in the study as compared to the entire population of patients receiving the medical therapy.

For example, assume the studied population included 40-percent obese patients and 60-percent patients not characterized as obese, whereas the entire population receiving the medical includes only 20-percent obese patients and 80-percent patients not characterized as obese. Further, assume that the obese patients in the study had a 50-percent mortality rate, whereas the patients not characterized as obese only had a 30-percent mortality rate. The mortality rate for the entire study population may calculated as follows. Specifically, the overall mortality rate for the patients in the study would then be: 0.4 (obese patients)*0.5 (obese mortality rate)+0.6 (not obese patients)*0.3 (not obese mortality rate)=0.38, i.e., a 38-percent mortality rate.

Using a simplistic model, the 38-percent mortality rate for the studied population can be modeled to the entire patient population receiving the medical therapy. As previously mentioned, the entire population receiving the medical therapy includes only 20-percent obese patients and 80 percent patients not characterized as obese. Using the relatively simple association between obesity and mortality the mortality rate for the entire population receiving the medical therapy may be modeled as follows: 0.2 (obese patients)*0.5 (obese mortality rate)+0.8 (not obese patients)*0.3 (not obese mortality rate)=0.34, i.e., a 34-percent mortality rate. Thus, the model predicts that the entire population receiving the medical therapy would have a 34-percent mortality rate within one year of the initiation of the medical therapy even though a 38-percent mortality rate was observed in the studied population.

In a slightly more complex model, suppose that the post-therapy outcome is systolic blood pressure, which is related to both age at baseline and the number of procedures that the treated physician has previously performed. Such a model as applied to an individual patient could be: systolic blood pressure=110+0.43*(age)−0.04*(number of procedures). In the study population, there might be equal numbers of patients in ten year intervals from 40 through 70, and that the mean systolic blood pressure in the study was 126. However, it could be the case that the entire population receiving the medical therapy is skewed towards older ages, so that the mean systolic blood pressure would be modeled to be 132, due to the higher ages present, even though the relative distribution of physician experience was similar between the study population and the entire population.

After modeling, a distribution of the at least one post-therapy outcome in the population, the computing device issues instructions to store an indication of the modeled distribution of the at least one post-therapy outcome in the population of patients on a data storage system (1010). The indication of the modeled distribution of the at least one post-therapy outcome in the population of patients on a data storage system represents one example of output data 116 (FIG. 6). In some examples, a representation of the modeled distribution may also be displayed to a user via a display device.

In some examples, the techniques of FIG. 10 may be initiated by manual intervention of a user. For example, the computing device may receive instructions from the user to access one or more of the baseline characteristics for the population and/or the subset of the population, the one or more post-therapy outcomes for the subset of the population, and/or an indication of the association between at least one aspect of the baseline characteristics and at least one of the post-therapy outcomes in the subset of the population.

In other examples, the computing device may automatically perform the techniques of FIG. 10 without manual intervention of a user. For example, the computing device may automatically initiate the modeling of the distribution of the at least one post-therapy outcome in the population in response to a predetermined time, a predetermined event or number of events, a change in baseline characteristics for the population available to the computing device, a change in baseline characteristics for the subset of population available to the computing device, and/or a change in the information regarding one or more post-therapy outcomes for the subset of population available to the computing device.

The techniques of FIG. 10 may be applied to populations in which each patient receives the same medical therapy or in which at least some patients receive different medical therapies. Generally, when some patients in the population receive different medical therapies, the medical therapies should be expected to produce similar associations between the baseline characteristics and the studied therapy outcomes. For example, the patients in the subset may receive an updated version of a preexisting medical device, and baseline data for both the patients with the preexisting medical device and the updated version of the preexisting medical device may be used to model of the distribution of the at least one post-therapy outcome in the population.

In accordance with the above example, the medical therapy received by a first group in the population of patients may include first medical treatment, but not a second medical treatment, and the medical therapy received by a second group in the population of patients includes the second medical treatment, but not the first medical treatment. In addition, the medical therapy received by the each of the patients in the subset of the population includes the first medical treatment, but not the second medical treatment.

In a different example, the results of two or more studies may be aggregated. In the case in which two distinct medical devices are studied separately, the results of both studies may be combined before the therapy outcomes for the entire patient population using either of the devices is modeled. For example, the medical therapy received by a first group in the population of patients includes a first medical treatment, but not a second medical treatment, wherein the medical therapy received by a second group in the population of patients may include the second medical treatment, but not the first medical treatment, the medical therapy received by a first group in the subset of the population may include the first medical treatment, but not the second medical treatment, and the medical therapy received by a second group in the subset of the population may include the second medical treatment, but not the first medical treatment.

Various examples have been described. These and other examples are within the scope of the following claims.

1. A method for evaluating a medical therapy with a computing device, the method comprising:
accessing, with the computing device, a data storage system to obtain baseline characteristics for a population of patients who each receive a medical therapy;
accessing, with the computing device, the data storage system to obtain baseline characteristics and information regarding one or more post-therapy outcomes for a subset of the population of patients;
accessing the data storage system to obtain an indication of an association between at least one aspect of the baseline characteristics and at least one of the post-therapy outcomes in the subset of the population;
modeling, with the computing device, a distribution of the at least one post-therapy outcome in the population based on a distribution of the at least one post-therapy outcome in the subset of the population and further based on a comparison of a distribution of the at least one aspect of the baseline characteristics in the subset of the population with a distribution of the at least one aspect of the baseline characteristics in the population;
storing, with the computing device, an indication of the modeled distribution of the at least one post-therapy outcome in the population of patients on the data storage system.

2. The method of claim 1, further comprising analyzing the post-therapy outcomes along with baseline characteristics for the subset of the population to determine the association between at least one aspect of the baseline characteristics and at least one of the post-therapy outcomes in the subset of the population.

3. The method of claim 1, further comprising comparing, with the computing device, the distribution of the at least one aspect of the baseline characteristics in the subset of the population with the distribution of the at least one aspect of the baseline characteristics in the population.

4. The method of claim 1, wherein the at least one post-therapy outcome is associated with the medical therapy.

5. The method of claim 1, wherein modeling the distribution of the at least one post-therapy outcome in the population includes:
modifying the distribution of the at least one post-therapy outcome in the subset of the population according to the relative distribution of the at least one aspect of the baseline characteristics in the subset of the population as compared to the distribution of the at least one aspect of the baseline characteristics in the population to produce the modeled distribution for the at least one post-therapy outcome in the population.

6. The method of claim 1, wherein modeling the distribution of the at least one post-therapy outcome in the population includes:
applying a model for the at least one post-therapy outcome in the subset of the population as a function of baseline characteristics in the subset of the population to the at least one post-therapy outcome in the population, wherein the modeled distribution for the at least one post-therapy outcome in the population is obtained by using the baseline characteristics in the population in the model in place of the baseline characteristics in the subset of the population in the model.

7. The method of claim 1, wherein modeling the distribution of the at least one post-therapy outcome in the population includes:
multiplying a prevalence of the at least one of the post-therapy outcome in a proportion of the subset of the population exhibiting the at least one distinct aspect of the baseline characteristics by a proportion of the population exhibiting the at least one distinct aspect of the baseline characteristics to produce a first value;
multiplying a prevalence of the at least one of the post-therapy outcome in a proportion of the subset of the population exhibiting the at least one separate distinct aspect of the baseline characteristics by a proportion of the population exhibiting the at least one separate distinct aspect of the baseline characteristics to produce a second value;
similarly calculating prevalence by proportion for each of the distinct observed aspects of the baseline characteristics to obtain additional values; and
summing these individual values together to produce a modeled prevalence value that represents the modeled distribution for the at least one post-therapy outcome in the population.

8. The method of claim 1, wherein modeling the distribution of the at least one post-therapy outcome in the population includes:
multiplying a prevalence of the at least one of the post-therapy outcome in a proportion of the subset of the population exhibiting the at least one aspect of the baseline characteristics by a proportion of the population exhibiting the at least one aspect of the baseline characteristics to produce a first value;
multiplying a prevalence of the at least one of the post-therapy outcomes in the proportion of the subset of the population not exhibiting the at least one aspect of the baseline characteristics by a proportion of the population not exhibiting the at least one aspect of the baseline characteristics to produce a second value; and
adding the first value to the second value to produce a modeled prevalence value that represents the modeled distribution for the at least one post-therapy outcome in the population.

9. The method of claim 1, further comprising automatically initiating, with the computing device, the modeling of the distribution of the at least one post-therapy outcome in the population in response to one or more of a group consisting of:
a predetermined time;
a predetermined event;
a predetermined number of the predetermined event;
a change in baseline characteristics for the population available to the computing device;
a change in baseline characteristics for the subset of population available to the computing device; and
a change in the information regarding one or more post-therapy outcomes for the subset of population available to the computing device.

10. The method of claim 1,
wherein the medical therapy received by a first group in the population of patients includes a first medical treatment, but not a second medical treatment,
wherein the medical therapy received by a second group in the population of patients includes the second medical treatment, but not the first medical treatment, and
wherein the medical therapy received by the each of the patients in the subset of the population includes the first medical treatment, but not the second medical treatment.

11. The method of claim 1,
wherein the medical therapy received by a first group in the population of patients includes a first medical treatment, but not a second medical treatment,
wherein the medical therapy received by a second group in the population of patients includes the second medical treatment, but not the first medical treatment,
wherein the medical therapy received by a first group in the subset of the population includes the first medical treatment, but not the second medical treatment, and
wherein the medical therapy received by a second group in the subset of the population includes the second medical treatment, but not the first medical treatment.

12. The method of claim 1, wherein the medical therapy for each of the population of patients includes one or more of a group consisting of:
an electrical stimulation therapy;
a cardiac stimulation therapy;
a medical lead implantation procedure;
a fluid delivery therapy;
a glucose monitoring and insulin delivery therapy;
a pharmaceutical therapy;
a biologic therapy;
a medical stent implantation procedure;
a heart valve implantation procedure;
a fixation cage for spinal surgery bone growth implantation procedure; and
an ablation therapy.

13. The method of claim 1, wherein the at least one aspect of the baseline characteristics includes one or more of a group consisting of:
patient date of birth;
geographic location of patient's residence;
geographic location of the medical therapy;
a metric of the skill of a practitioner associated with the delivery of the medical therapy;
a metric of the experience of a practitioner associated with the delivery of the medical therapy;
a size of a medical facility associated with the delivery of the medical therapy; and
a metric of the experience of a medical facility associated with the delivery of the medical therapy.

14. The method of claim 1, wherein the at least one post therapy outcome includes one or more of a group consisting of:
time to first occurrence of an event;
a proportion of patients with a given post therapy outcome at a certain point in time;
a patent questionnaire;
a clinician patient evaluation; and
a medical test result.

15. The method of claim 1, further comprising generating patient-centric records in a data warehouse after receiving data from multiple data sources, the data from the data sources providing the baseline characteristics for the population, the baseline characteristics for the subset of the population, and the one or more post-therapy outcomes for the subset of the population, each of the patient-centric records storing patient data regarding a different patient in the population, the patient data stored in the patient-centric records being based on the data received from the data sources.

16. A computing device comprising:
a data storage system that stores:
baseline characteristics for a population of patients who each receive a medical therapy, and
baseline characteristics and information regarding one or more post-therapy outcomes for a subset of the population of patients; and
a processing system coupled to the data storage system, the processing system reading instructions from the data storage system and executing the instructions, execution of the instructions by the processing system causing a computing device to:
access the baseline characteristics for the population and the baseline characteristics and information regarding one or more post-therapy outcomes for the subset of the population from the data storage system;
model a distribution of at least one post-therapy outcome in the population based on a distribution of the at least one post-therapy outcome in the subset of the population and further based on a comparison of a distribution of at least one aspect of the baseline characteristics in the subset of the population with the distribution of the at least one aspect of the baseline characteristics in the population, and
store an indication of the modeled distribution of the at least one post-therapy outcome in the population of patients on the data storage system.

17. The computing device of claim 16, wherein modeling the distribution of the at least one post-therapy outcome in the population includes:
modifying the distribution of the at least one post-therapy outcome in the subset of the population according to the relative distribution of the at least one aspect of the baseline characteristics in the subset of the population as compared to the distribution of the at least one aspect of the baseline characteristics in the population to produce the modeled distribution for the at least one post-therapy outcome in the population.

18. The computing device of claim 16, wherein modeling the distribution of the at least one post-therapy outcome in the population includes:
applying a model for the at least one post-therapy outcome in the subset of the population as a function of baseline characteristics in the subset of the population to the at least one post-therapy outcome in the population, wherein the modeled distribution for the at least one post-therapy outcome in the population is obtained by using the baseline characteristics in the population in the model in place of the baseline characteristics in the subset of the population in the model.

19. The computing device of claim 16, wherein modeling the distribution of the at least one post-therapy outcome in the population includes:
multiplying a prevalence of the at least one of the post-therapy outcome in a proportion of the subset of the population exhibiting the at least one distinct aspect of the baseline characteristics by a proportion of the population exhibiting the at least one distinct aspect of the baseline characteristics to produce a first value;
multiplying a prevalence of the at least one of the post-therapy outcome in a proportion of the subset of the population exhibiting the at least one separate distinct aspect of the baseline characteristics by a proportion of the population exhibiting the at least one separate distinct aspect of the baseline characteristics to produce a second value;
similarly calculating prevalence by proportion for each of the distinct observed aspects of the baseline characteristics to obtain additional values; and
summing these individual values together to produce a modeled prevalence value that represents the modeled distribution for the at least one post-therapy outcome in the population.

20. The computing device of claim 16, wherein execution of the instructions by the processing system further cause the computing device to:
automatically initiate the modeling of the distribution of the at least one post-therapy outcome in the population in response to one or more of a group consisting of:
a predetermined time;
a predetermined event;
a predetermined number of the predetermined event;
a change in baseline characteristics for the population available to the computing device;
a change in baseline characteristics for the subset of population available to the computing device; and
a change in the information regarding one or more post-therapy outcomes for the subset of population available to the computing device.

21. The computing device of claim 16, wherein the medical therapy for each of the population of patients includes one or more of a group consisting of:
an electrical stimulation therapy;
a cardiac stimulation therapy;
a medical lead implantation procedure;
a fluid delivery therapy;
a glucose monitoring and insulin delivery therapy;
a pharmaceutical therapy;
a biologic therapy;
a medical stent implantation procedure;
a heart valve implantation procedure;
a fixation cage for spinal surgery bone growth implantation procedure; and
an ablation therapy.

22. The computing device of claim 16, wherein execution of the instructions by the processing system further cause the computing device to:
generate patient-centric records in a data warehouse after receiving data from multiple data sources, the data from the data sources providing the baseline characteristics for the population, the baseline characteristics for the subset of the population, and the one or more post-therapy outcomes for the subset of the population, each of the patient-centric records storing patient data regarding a different patient in the population, the patient data stored in the patient-centric records being based on the data received from the data sources.

23. A computer storage medium that stores instructions, execution of the instructions by a processing system of a computing device causing the computing device to:
access baseline characteristics for a population of patients who each receive a medical therapy;
access baseline characteristics and information regarding one or more post-therapy outcomes for a subset of the population of patients;
access an indication of an association between at least one aspect of the baseline characteristics and at least one of the post-therapy outcomes in the subset of the population;
model a distribution of the at least one post-therapy outcome in the population based on a distribution of the at least one post-therapy outcome in the subset of the population and further based on a comparison of a distribution of the at least one aspect of the baseline characteristics in the subset of the population with the distribution of the at least one aspect of the baseline characteristics in the population;
store an indication of the modeled distribution of the at least one post-therapy outcome in the population of patients on a data storage system.

24. The computer storage medium of claim 23, wherein modeling the distribution of the at least one post-therapy outcome in the population includes:
modifying the distribution of the at least one post-therapy outcome in the subset of the population according to the relative distribution of the at least one aspect of the baseline characteristics in the subset of the population as compared to the distribution of the at least one aspect of the baseline characteristics in the population to produce the modeled distribution for the at least one post-therapy outcome in the population.

25. The computer storage medium of claim 23, wherein modeling the distribution of the at least one post-therapy outcome in the population includes:
applying a model for the at least one post-therapy outcome in the subset of the population as a function of baseline characteristics in the subset of the population to the at least one post-therapy outcome in the population, wherein the modeled distribution for the at least one post-therapy outcome in the population is obtained by using the baseline characteristics in the population in the model in place of the baseline characteristics in the subset of the population in the model.

26. The computer storage medium of claim 23, wherein modeling the distribution of the at least one post-therapy outcome in the population includes:
multiplying a prevalence of the at least one of the post-therapy outcome in a proportion of the subset of the population exhibiting the at least one distinct aspect of the baseline characteristics by a proportion of the population exhibiting the at least one distinct aspect of the baseline characteristics to produce a first value;
multiplying a prevalence of the at least one of the post-therapy outcome in a proportion of the subset of the population exhibiting the at least one separate distinct aspect of the baseline characteristics by a proportion of the population exhibiting the at least one separate distinct aspect of the baseline characteristics to produce a second value;
similarly calculating prevalence by proportion for each of the distinct observed aspects of the baseline characteristics to obtain additional values; and
summing these individual values together to produce a modeled prevalence value that represents the modeled distribution for the at least one post-therapy outcome in the population.

27. The computer storage medium of claim 23, wherein execution of the instructions by the processing system further cause the computing device to:
automatically initiate the modeling of the distribution of the at least one post-therapy outcome in the population in response to one or more of a group consisting of:
a predetermined time;
a predetermined event;
a change in baseline characteristics for the population available to the computing device;
a change in baseline characteristics for the subset of population available to the computing device; and
a change in the information regarding one or more post-therapy outcomes for the subset of population available to the computing device.

28. The computer storage medium of claim 23, wherein the medical therapy for each of the population of patients includes one or more of a group consisting of:
an electrical stimulation therapy;
a cardiac stimulation therapy;
a medical lead implantation procedure;
a fluid delivery therapy;
a glucose monitoring and insulin delivery therapy;
a pharmaceutical therapy;
a biologic therapy;
a medical stent implantation procedure;
a heart valve implantation procedure;
a fixation cage for spinal surgery bone growth implantation procedure; and
an ablation therapy.

29. The computer storage medium of claim 23, wherein execution of the instructions by the processing system further cause the computing device to:
generate patient-centric records in a data warehouse after receiving data from multiple data sources, the data from the data sources providing the baseline characteristics for the population, the baseline characteristics for the subset of the population, and the one or more post-therapy outcomes for the subset of the population, each of the patient-centric records storing patient data regarding a different patient in the population, the patient data stored in the patient-centric records being based on the data received from the data sources.

30. A system comprising:
means for modeling the distribution of post-therapy outcomes in a population of patients based on a distribution of the post-therapy outcomes in a subset of the population and further based on a comparison of a distribution of baseline characteristics in the subset of the population with a distribution of the baseline characteristics in the population; and
means for storing an indication of the modeled distribution of the post-therapy outcomes in the population of patients on a data storage system.
